(19) United States
(12) Patent Application Publication
(10) Pub. No.: US 2020/0086656 A1
(43) Pub. Date: Mar. 19, 2020

(54) JIG FOR IMAGE FORMING APPARATUS, IMAGE FORMING SYSTEM, AND JIG SET FOR IMAGE FORMING APPARATUS

(71) Applicant: Mitsutaka NAKAMURA, Kanagawa (JP)

(72) Inventor: Mitsutaka NAKAMURA, Kanagawa (JP)

(73) Assignee: Ricoh Company, Ltd., Tokyo (JP)

(21) Appl. No.: 16/511,524

(22) Filed: Jul. 15, 2019

(30) Foreign Application Priority Data
Sep. 14, 2018 (JP) 2018-172513

(51) Int. Cl. B41J 3/36; B41J 3/407; B41J 2/01

(52) U.S. Cl. CPC B41J 3/36; B41J 2/01; B41J 3/407

(57) ABSTRACT

A jig for an image forming apparatus that forms an image on a recording medium with movement in a scanning direction includes a base including an apparatus positioning reference extending in a first direction to be aligned with the scanning direction. The apparatus positioning reference is a reference in positioning the image forming apparatus in a second direction orthogonal to the first direction. The jig further include a displacement stopper configured to prevent a relative positional displacement between the jig and the recording medium, and a switching device configured to switch the displacement stopper between an operating state and a non-operating state.

### CROSS-REFERENCE TO RELATED APPLICATION

This patent application is based on and claims priority pursuant to 35 U.S.C. § 119(a) to Japanese Patent Application No. 2018-172513, filed on Sep. 14, 2018, in the Japan Patent Office, the entire disclosure of which is hereby incorporated by reference herein.

### BACKGROUND

### Technical Field

The present disclosure relates to a jig for an image forming apparatus, an image forming system, and a jig set for the image forming apparatus.

### Description of the Related Art

There are jigs for positioning of a mobile image forming apparatuses. Such a jig includes an apparatus positioning reference for positioning of the mobile image forming apparatus in a direction orthogonal to a scanning direction of the mobile image forming apparatus. In image formation, a user moves the mobile image forming apparatus in the scanning direction on a recording medium.

### SUMMARY

An embodiment of this disclosure provides a jig for an image forming apparatus that forms an image on a recording medium with movement in a scanning direction. The jig includes a base including an apparatus positioning reference extending in a first direction to be aligned with the scanning direction. The apparatus positioning reference is a reference in positioning the image forming apparatus in a second direction orthogonal to the first direction. The jig further include a displacement stopper configured to prevent a relative positional displacement between the jig and the recording medium, and a switching device configured to switch the displacement stopper between an operating state and a non-operating state.

According to another embodiment, an image forming system includes the image forming apparatus; and the above-described jig to be used in positioning the image forming apparatus.

Another embodiment provides a jig set for an image forming apparatus. The jig set includes the jig described above, and an attachment to be attached to the image forming apparatus. The attachment includes a contacted portion to which the apparatus positioning reference contacts when the attachment is attached to the image forming apparatus.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exterior perspective view illustrating a handheld printer according to an embodiment, as viewed from obliquely above;

FIG. 2 is a perspective view illustrating the handheld printer being moved;

FIG. 3 is a perspective view illustrating the handheld printer with an upper unit opened horizontally relative to a lower unit;

FIG. 4 is a bottom view of the handheld printer as viewed from a recording side;

FIG. 5 is a block diagram illustrating a part of an electric circuit of the handheld printer;

FIG. 6 is an exterior perspective view illustrating a jig according to an embodiment, as viewed from obliquely above;

FIG. 7 is an enlarged view illustrating sheet positioning members of the jig;

FIG. 8 is a schematic view illustrating the handheld printer positioned at a scanning start position (home position) in a scanning direction placed alongside the jig;

FIG. 9 is an enlarged view illustrating an attachment attached to the handheld printer;

FIG. 10 is a perspective view illustrating a bottom face of the jig;

FIG. 11A is a side view of the jig placed on a workbench on which a paper sheet is placed;

FIG. 11B is an enlarged view of a part D and a part E of FIG. 11A;

FIG. 12A is an enlarged perspective view illustrating the positions of high friction members when a user does not push down a pressed portion;

FIG. 12B is an enlarged perspective view illustrating the position of the high friction members when the user pushes down the pressed portion;

FIG. 13 is an exploded perspective view illustrating a main section of the jig;

FIG. 14 is an exploded perspective view illustrating a bottom face of the main section of the jig;

FIG. 15 is an enlarged view of a part G of FIG. 14;

FIG. 16 is a view illustrating a state where compression coil springs are attached to the pressed portion;

FIG. 17 is an enlarged perspective view illustrating a state where the pressed portion is attached to an orthogonal-direction positioning member;

FIG. 18 is a perspective view illustrating a bottom face of a jig according to a comparative example;

FIG. 19 is a schematic view illustrating how the handheld printer produces letter images such as an occasion type or a sender name of a gift, using the jig according to the comparative example, on an A4-sized wrapping sheet with a gift ribbon image printed on the paper;

FIG. 20 is an explanatory view illustrating the jig according to the comparative example, with the handheld printer set on the wrapping sheet;

FIG. 21 is a schematic view illustrating a state where a user manually moves the handheld printer to produce letter images such as a sender name on the wrapping sheet;

FIG. 22 is a schematic view illustrating a state where, after a letter image representing an occasion type is formed on the wrapping sheet, letter images representing names of two senders are formed in two lines in the direction orthogonal to the scanning direction;

FIG. 23 is a schematic view illustrating the jig according to the comparative example, set on the wrapping sheet;

FIG. 24 is a schematic view illustrating a case where, after a letter image of the first line is formed, the jig is set on the wrapping sheet so as to produce a letter image of the second line at a targeted position thereof;

FIG. 25 is a perspective view of the jig, according to a variation, as viewed from obliquely above;

FIG. 26 is a perspective view of a bottom face of the jig according to the variation;

FIG. 27A is an enlarged side view of a main section of the jig according to the variation, when a user does not push down the pressed portion; and

FIG. 27B is an enlarged perspective view of the main section of the jig according to the variation, when the user pushes down the pressed portion.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

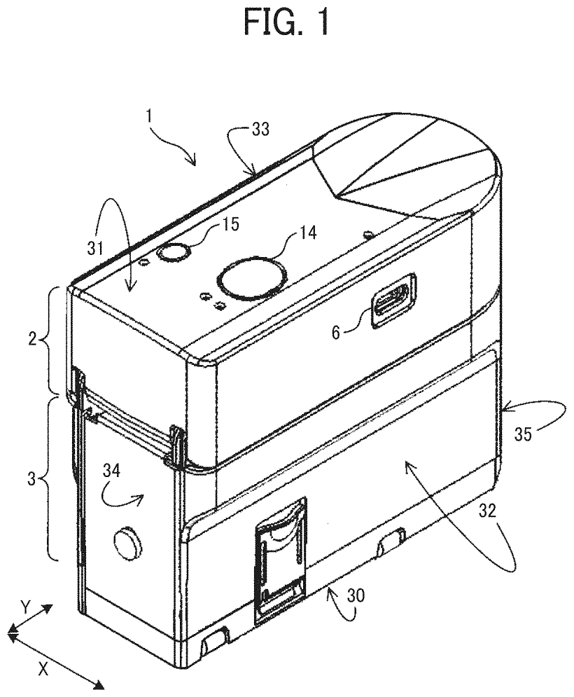

Referring now to the drawings, wherein like reference numerals designate identical or corresponding parts throughout the several views thereof, and particularly to FIG. 1, an image forming apparatus according to an embodiment of this disclosure is described. As used herein, the singular forms “a”, “an”, and “the” are intended to include the plural forms as well, unless the context clearly indicates otherwise.

Descriptions are given below of a handheld mobile inkjet printer (hereinafter referred to as “handheld printer”) that is a mobile image forming apparatus, a jig for the handheld printer (hereinafter simply referred to as “jig”), and a mobile image forming system including the handheld printer and the jig, as embodiments of the present disclosure.

First, a basic configuration of the handheld printer according to the present embodiment is described.

FIG. 1 is an exterior perspective view of the handheld printer 1 according to the present embodiment, as viewed from obliquely above.

The handheld printer 1 illustrated in FIG. 1 includes an upper unit 2 and a lower unit 3. The handheld printer 1 as a whole is shaped like a rectangular parallelepiped. In a scanning direction, that is, a printing direction indicated by arrow X in FIG. 1 (X direction), the handheld printer has such a width that a user can grasp the handheld printer with a palm.

A housing of the handheld printer 1 includes a recording side 30, an upper side 31 opposite the recording side 30, a left side 32 facing in the scanning direction indicated by arrow X. On the recording side 30, a recording section (an image forming section) of an inkjet head 40, which is described later, faces a recording medium, such as a paper sheet. The handheld printer 1 also includes a right side 33 facing in the scanning direction, a rear side 34 facing in a direction indicated by arrow Y, orthogonal to the scanning direction, a front side 35 facing in the direction orthogonal to the scanning direction. In the description below, “orthogonal direction” represents the direction orthogonal to the scanning direction of the handheld printer 1 and along the surface of the recording medium, unless otherwise specified.

FIG. 1 illustrates the handheld printer 1 being in such a posture that the recording side 30 (i.e., a bottom face in FIG. 1) is faced vertically down and the upper side 31 is faced vertically up. A print button 14 and a power button 15 are disposed within an outer edge (within a frame) of the upper side 31. The left side 32 of the upper unit 2 includes a universal serial bus (USB) connection port 6.

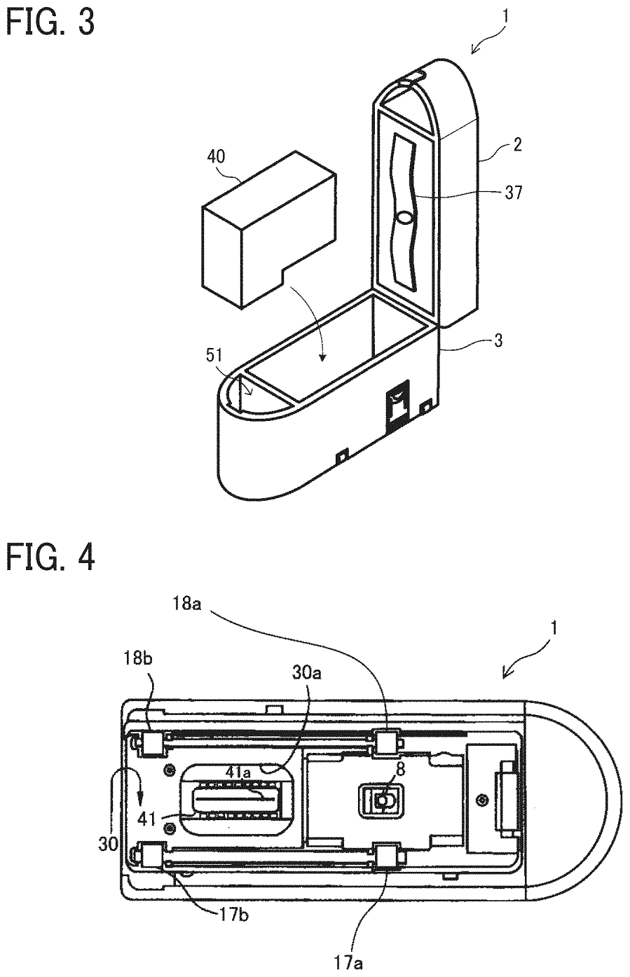

The USB connection port 6 is a port for connecting a USB cable. The handheld printer 1 is provided with a rechargeable battery (battery 51 illustrated in FIG. 3) mounted therein. The battery 51 can be charged when electric power is supplied thereto from an external power supply via the USB cable connected to the USB connection port 6.

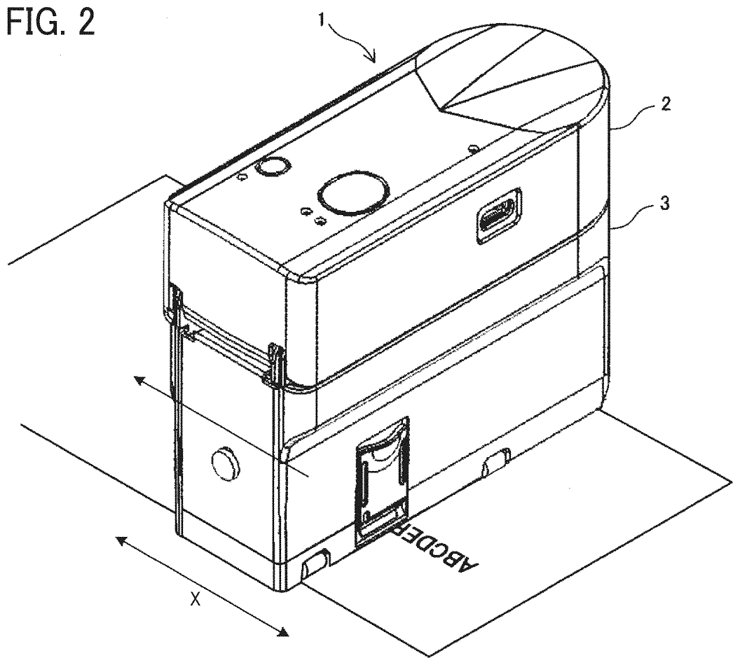

The user can switch on and off the power of the handheld printer 1 by holding down the power button 15 for a while. When the power is turned on, a control board provided in the upper unit 2 of the handheld printer 1 can acquire image data by short-range wireless communication with an external device, such as a smartphone or the like. After the user places the handheld printer 1 on the surface of a recording medium with the recording side 30 facing the recording medium, the user presses the print button 14 once and moves the handheld printer 1 in the scanning direction indicated by arrow X as illustrated in FIG. 2, thus forming an image on the recording medium. The handheld printer 1 can form an image on the surface of the recording medium in both of forward movement and backward movement in the scanning direction (manual scanning) when the user moves the handheld printer 1 back and forth.

The recording medium is not limited to paper, such as paper sheets, but includes any image recordable medium, for example, overhead projector (OHP) sheets, cloth, cardboards, packaging containers, glass, and substrates.

FIG. 3 is a perspective view of the handheld printer 1 in a state in which the upper unit 2 is opened with respect to the lower unit 3.

As illustrated in FIG. 3, the upper unit 2 is held by the lower unit 3 to open and close with respect to the lower unit 3. The battery 51 to supply power to each device of the handheld printer 1 is housed in an inner space of the lower unit 3.

An inkjet head 40 (an ink cartridge), which includes the recording section and an ink tank combined into a single unit, is mounted inside the lower unit 3. At this time, the recording portion to discharge ink droplets is faced down in the vertical direction. The inkjet head 40 discharges ink droplets from the recording section to record an image on a recording medium.

On the inner face of the upper unit 2, a head-pressing flat spring 37 to press and hold the inkjet head 40 mounted in the lower unit 3 is attached.

In the handheld printer 1, since the battery 51 is disposed on a side of the inkjet head 40 in the lower unit 3, the height of the handheld printer 1 is smaller compared with a configuration in which the battery is disposed above the inkjet head. Such placement lowers the position of the center of gravity of the handheld printer 1, thus preventing the handheld printer 1 from falling over while being moved (manual scanning).

FIG. 4 is a bottom view of the handheld printer 1 as viewed from the recording side;

In FIG. 4, the recording side 30 of the handheld printer 1 includes an opening 30a to expose a recording section 41 of the inkjet head 40 mounted in the lower unit 3 (FIG. 3) to the outside. The recording section 41 includes a plurality of discharge nozzles 41a and is capable of discharging ink droplets separately from the respective discharge nozzles 41a as actuators (driving sources) are driven.

The recording section 41 is a region inside (on the side of the discharge nozzles 41a) a plurality of inner leads surrounding the discharge nozzles 41a along the surface of the substrate of the inkjet head 40. In the handheld printer 1, the area of the recording section 41 on the substrate is painted white to be clearly distinguished from the surrounding black area. In other words, the white area is a mark representing the recording section 41. The shape of the mark is rectangular as illustrated in the drawing.

As a driving source to discharge ink, the inkjet head 40 employs, for example, electromechanical transducer elements, such as piezoelectric actuators (lamination-type piezoelectric elements or thin-film-type piezoelectric elements), electrothermal transducer elements including heating elements, or electrostatic actuators, made of diaphragms and opposed electrodes.

The “ink liquid” discharged from the discharge nozzles 41a of the recording section 41 is not particularly limited as long as the liquid has a viscosity and a surface tension that enable discharge from the discharge nozzles 41a. However, it is preferable that the viscosity is 30 mPa·s or less under ordinary temperature and pressure or by heating or cooling. Specifically, the term “ink (liquid)” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, surface treatment liquid, a liquid for forming components of electronic element or light-emitting element or a resist pattern of electronic circuit, or a material solution for three-dimensional fabrication.

Inside the outer edge of the recording side 30, a position detection sensor 8 as a detector to detect the position of the handheld printer 1 on the recording medium, a first left roller 17a, a second left roller 17b, a first right roller 18a, and a second right roller 18b that are rotatable are disposed.

When the user moves (manual scanning) the handheld printer 1 in the scanning direction, the four rollers contacting the surface of the recording medium rotate like tires. Owing to such roller mechanism, the user can advance the handheld printer 1 straight in the scanning direction. At this time, only the four rollers of the handheld printer 1 are in contact with the surface of a recording medium, and the recording side 30 is not in contact with the surface of the recording medium. Therefore, a constant distance can be maintained between the recording section 41 of the inkjet head 40 and the surface of the recording medium, thus forming a desired high-quality image.

The position detection sensor 8 is a sensor to detect the distance to the surface of the recording medium, the surface state (for example, asperities) of the recording medium, and the distance by which the handheld printer 1 has traveled. The position detection sensor 8 is similar to a sensor used for, for example, an optical mouse (a pointing device) of a personal computer. The position detection sensor 8 irradiates, with light, a place (recording medium) where the position detection sensor 8 is placed and reads the state of the place as a “pattern”. The position detection sensor 8 sequentially detects how the “pattern” moves relative to the movement of the position detection sensor 8, to calculate the amount of movement.

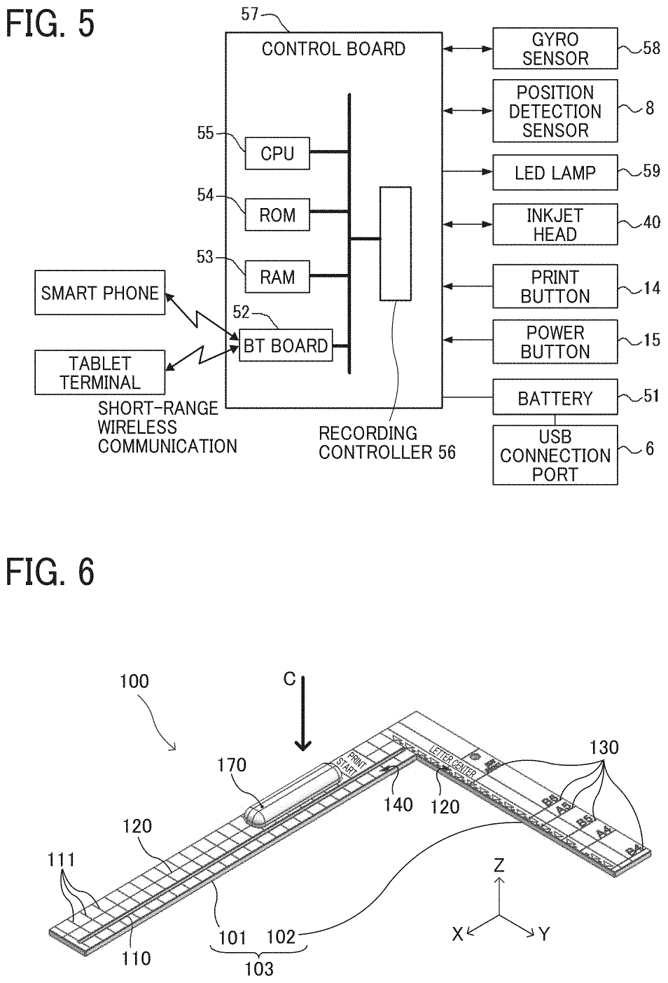

FIG. 5 is a block diagram illustrating a portion of an electric circuit of the handheld printer 1.

A control board 57 includes a central processing unit (CPU) 55 that performs various arithmetic processing and program execution, a Bluetooth (registered trademark) board (BT board) 52 for short-range wireless communication, a random access memory (RAM) 53 that temporarily stores data, a read-only memory (ROM) 54, and a recording controller 56. The control board 57 is secured at a position on the back side of the USB connection port 6 (illustrated in FIG. 2) in a hollow space of the upper unit 2 (illustrated in FIG. 1).

The BT board 52 performs data communication by short-range wireless communication (Bluetooth communication) with an external device, such as a smartphone or a tablet terminal. The ROM 54 stores, for example, firmware for hardware control of the handheld printer 1 and drive waveform data of the inkjet head 40. The recording controller 56 executes data processing for driving the inkjet head 40 and generates drive waveforms.

The control board 57 is electrically connected to a gyro sensor 58, the position detection sensor 8, a light emitting diode (LED) lamp 59, the inkjet head 40, the print button 14, the power button 15, the battery 51, and the like.

The gyro sensor 58 detects the tilt and rotation angle of the handheld printer 1 and transmits the result of detection to the control board 57. The LED lamp 59 is disposed inside an exterior cover made of a light transmissive material of the print button 14 and makes the print button 14 luminous.

When the power button 15 is pressed to turn on the power of the handheld printer 1, power is supplied to each module. The CPU 55 initiates startup according to the program stored in the ROM 54 and loads the program and each data in the RAM 53. When data of an image to be formed is received from an external device by short-range wireless communication, the recording controller 56 generates a drive waveform corresponding to the image data. Then, the discharge of ink from the inkjet head 40 is controlled to form an image corresponding to the position on the surface of the recording medium detected by the position detection sensor 8.

In response to acquisition of image data via short-range wireless communication from an external device, the control board 57 illustrated in FIG. 5 causes the LED lamp 59 to blink so that the light transmissive print button 14, which transmits light, becomes luminous and blinks. Seeing such blinking, the user knows that the acquisition of the image data by the handheld printer 1 has ended. Then, the user places the handheld printer 1 on the recording medium and presses the print button 14.

Meanwhile, as the control board 57 starts blinking of the LED lamp 59, the control board 57 waits for pressing of the print button 14. When the print button 14 is pressed, the control board 57 causes the LED lamp 59 to keep emitting light so that the print button 14 continuously emits light. Seeing the continuous light emission, the user starts moving (manual scanning) the handheld printer 1 in the scanning direction.

Finishing moving (manual scanning) of the handheld printer 1, the user picks up the handheld printer 1 from the recording medium and places the handheld printer 1 on a table or the like. When the handheld printer 1 is picked up from the recording medium, the position detection sensor 8 does not detect the position. At the timing when the position detection sensor 8 no longer detects the position, the control board 57 turns off the LED lamp 59 and stops lighting of the print button 14. Seeing the stop of lighting, the user knows that the operation of the handheld printer 1 for printing has ended.

It is not necessary to keep pushing the print button 14 while the user moves (manual scanning) the handheld printer 1. Once the print button 14 is pushed and released before the moving of the handheld printer 1, the image forming operation based on the detection result by the position detection sensor 8 is continued until the end of the image formation or the end of the position detection by the position detection sensor 8.

Next, descriptions are given below of a jig configuration according to the present embodiment.

FIG. 6 is a perspective view illustrating an exterior of a jig 100 according to the present embodiment, as viewed from obliquely above.

The jig 100 according to the present embodiment includes an orthogonal-direction positioning member 101 (a first portion) extending in the scanning direction (X direction) of the handheld printer 1 and a sheet positioning reference member 102 (a second portion) extending in an orthogonal direction (Y direction) of the handheld printer 1, both of which are shaped like long plates and combined together (may be molded together) into a base 103, as a main unit, so that relative positions thereof are fixed. Specifically, the base layer is shaped like a character “L”, with one end of the orthogonal-direction positioning member 101 and one end of the sheet positioning reference member 102 are jointed together, like an L-shaped ruler. The base 103 of the jig 100 is preferably made of a light-transmissive material and transparent, so that a portion of a paper sheet (the recording medium, described later) overlapped with the jig 100 can be visually recognized through the jig 100.

In the jig 100 according to the present embodiment, the orthogonal-direction positioning member 101 includes a groove 110 extending in the scanning direction (X direction). The groove 110 is used as a reference for determining the position of the handheld printer 1 (i.e., an apparatus positioning reference) in the orthogonal direction (Y direction). As a projection (described later) of the handheld printer 1 fits in the groove 110, inner wall surfaces of the groove 110 contact the projection, from both sides of the projection in the orthogonal direction. Then, the position of the handheld printer 1 in the orthogonal direction is regulated. In this state, the user moves the handheld printer 1 (manual scanning) in the scanning direction (X direction) while regulating the position of the handheld printer 1 in the orthogonal direction with the groove 110. Thus, the handheld printer 1 can be moved straight in the scanning direction, and displacements in the orthogonal direction can be reduced in an image formed on a paper sheet.

In the present embodiment, the apparatus positioning reference is the groove 110 into which the projection of the handheld printer 1 is inserted. However, the apparatus positioning reference is not limited to the groove 110 but can be any structure that contacts the projection of the handheld printer 1 from both sides in the orthogonal direction, thereby retaining the position of the handheld printer 1 in the orthogonal direction.

Although the apparatus positioning reference according to the present embodiment is configured to inhibit the displacement of the handheld printer 1 to both sides in the orthogonal direction, the apparatus positioning reference can be configured to inhibit the displacement of the handheld printer 1 to one side in the orthogonal direction. For example, in the case in which the user moves the handheld printer 1 (manual scanning) with a side (e.g., the rear side 34) of the handheld printer 1 pressed against a side face (facing in the orthogonal direction) of the orthogonal-direction positioning member 101, the side face of the orthogonal-direction positioning member functions as the apparatus positioning reference.

Further, on the orthogonal-direction positioning member 101 of the jig 100 according to the present embodiment, sheet reference lines 111 are drawn, as an operation by a user one orthogonal-direction recording medium reference line, extending along the orthogonal direction (Y direction). The sheet reference lines 111 are printed on the base. With the sheet reference lines 111, the user can set the jig 100 on a paper sheet so that a reference line segment on the paper sheet extending in the orthogonal direction (for example, a line segment drawn on the sheet or an end of the sheet, extending in the orthogonal direction) is parallel to the sheet reference lines 111 on the jig 100. Such setting can inhibit askew image formation on the paper sheet.

Further, on the orthogonal-direction positioning member 101 of the jig 100 according to the present embodiment, sheet reference lines 112 are drawn, as an operation by a user one recording medium reference line, extending along the scanning direction (X direction). The sheet reference lines 112 are printed on the base 103. With the sheet reference lines 112, the user can set the jig 100 on a paper sheet so that a reference line segment on the paper sheet extending in the scanning direction (for example, a line segment drawn on the sheet or an end of the sheet, extending in the orthogonal direction) is parallel to the sheet reference lines 112 on the jig 100. Such setting can inhibit askew image formation on the paper sheet.

Meanwhile, the sheet positioning reference member 102 of the jig 100 according to the present embodiment includes references for determining the position of the jig 100 (i.e., jig positioning references) relative to a paper sheet in the orthogonal direction (Y direction). In the present embodiment, the jig positioning references are indications of predetermined reference portions on a paper sheet, that is, a recording medium position indication in the orthogonal direction. In the present embodiment, an end of the sheet in the orthogonal direction serves as the reference portion on a paper sheet, and the medium position indications are sheet end indications 130 indicating the end position of the paper sheet in the orthogonal direction. The sheet end indications 130 are printed on the base 103.

In the present embodiment, as illustrated in FIG. 6, the sheet end indications 130 are disposed at positions different in distance from the groove 110 in the orthogonal direction (Y direction). The positions of the sheet end indications 130 different in the orthogonal direction are set, respectively, corresponding to a plurality of predetermined paper sheet sizes different in width in the orthogonal direction. Specifically, in a state in which the jig 100 is positioned on a paper sheet so that an end (the reference portion on the sheet) of each of the predetermined sheet sizes are aligned with the corresponding sheet end indication 130, the position of the recording section 41 of the handheld printer 1 in the orthogonal direction is positioned at a predetermined target position on the paper sheet.

In the jig 100 according to the present embodiment, the positions of the sheet end indications 130 are set such that the predetermined target positions on the corresponding sheet are center positions of the paper sheet in the orthogonal direction. In other words, the position of each sheet end indication 130 in the orthogonal direction is set so that an image is formed at the center of a paper sheet in the orthogonal direction when an end (the reference portion) of the corresponding size paper sheet is aligned with the sheet end indication 130.

Further, on the sheet positioning reference member 102 of the jig 100 according to the present embodiment, a pressed portion 170 as an operation portion is disposed. As illustrated with an arrow C in the FIG. 6, pressing the pressed portion 170 causes high friction members 150, described later, to contact a paper sheet, and a function to prevent positional displacement of the paper sheet is activated. When the pressed portion 170 is not pressed, the high friction members 150 retreat from the paper sheet and the function to prevent positional displacement is deactivated.

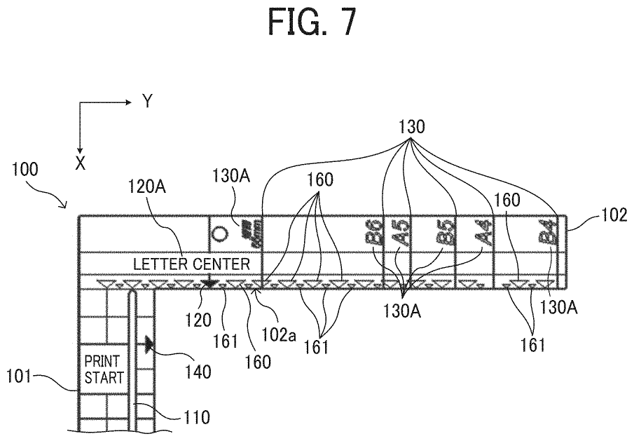

FIG. 7 is an enlarged view illustrating the sheet positioning reference member 102 of the jig 100.

The sheet end indications 130 on the sheet positioning reference member 102 of the jig 100 are line-shaped marks extending in the scanning direction (X direction). The sheet end indications 130 according to the present embodiment are disposed at different positions in the orthogonal direction respectively corresponding to a plurality of predetermined sheet sizes, such as “strip 55 mm”, “B6”, “A5”, “B5”, “A4”, and “B4”. Each sheet end indication 130 is given a paper sheet size indication so that the user can distinguish the plurality of sheet end indications for different paper sheet types (sizes). For example, size marks, such as “A4” indicating a paper sheet size, are provided on the sheet end indications 130.

In the jig 100 according to the present embodiment, the various indications (marks) and the various indicators are given by printing such as resin printing, pasting of seals, processing on the base layer, or the like. In the case of printing or pasting, color-coding can be used according to types of indications, depending on the differences in the purpose of indications.

According to the present embodiment, the sheet positioning reference member 102 further includes an image formation position indicator 120. When the projection of the handheld printer 1 is inserted in the groove 110 and the handheld printer 1 is positioned in the orthogonal direction, the image formation position indicator 120 indicates the position at which an image is formed by the handheld printer 1 in the orthogonal direction. The image formation position indicator 120 is, for example, a triangular mark, or an arrow formed with a triangular mark and a line segment extending in the scanning direction. In the present embodiment, preferably, the jig 100 is provided with a mark so that the user can understand which part of the image to be formed is pointed by the image formation position indicator 120 in the orthogonal direction. In FIG. 7, this indication enables the user to recognize that the image formation position indicator 120 points at the center position of the image (the letter) to be formed in the orthogonal direction.

Further, the sheet positioning reference member 102 of the jig 100 includes line space indications 160. The line space indications 160 are disposed with regard to the image formation position indicator 120 at intervals equivalent to one line space in the orthogonal direction when an image of one line is formed in one scanning. The line space indications 160 are respectively disposed at different positions in the orthogonal direction on the sheet positioning reference member 102. Providing the line space indications 160 on the jig 100 is advantageous when an image extending over a plurality of lines is formed. Since the user is given a guide for distance between lines, the image extending over a plurality of lines can be easily formed with constant line spaces.

The distance between the lines indicated by the line space indications 160 for determining the position in the orthogonal direction can be suitably set in accordance with the specifications of the handheld printer 1 (maximum image length formable by the handheld printer 1 in the orthogonal direction, etc.) or the manner of use by the user (letter image size used by the user). In the jig 100 according to the present embodiment, one line space is set to the length of the recording section 41 of the inkjet head 40 of the handheld printer 1 in the orthogonal direction, and the respective positions of the line space indications 160 in the orthogonal direction are determined accordingly. With such a configuration, when an image extending over a plurality of lines is formed with reference to the line space indications 160, overlapping of the adjacent lines in the image can be avoided.

In addition, setting the line space to the length of the recording section 41 in the orthogonal direction as described above is advantageous when a plurality of partial images extending over a plurality of lines is formed on a paper sheet with image formation of the maximum length in the orthogonal direction of the handheld printer 1 and combined into one image. In this case, displacements among the partial images in the orthogonal direction can be reduced, and the quality of the combined image can be high.

Further, in the jig 100 according to the present embodiment, auxiliary indications 161 smaller than the line space indications 160 are respectively disposed between the adjacent line space indications 160. This configuration is advantageous when the user wants to form an image extending over a plurality of lines with line spacing different from the line spacing indicated by the line space indications 160. The user can adjust the relative positions between the jig 100 and a wrapping sheet P with reference also to the auxiliary indications 161 so that the target line spacing is achieved. Therefore, even in the case of image formation over a plurality of lines with line spacing different from the spacing indicated by the line space indications 160, an image extending over a plurality of lines can be easily formed with constant line spacing.

Further, in the present embodiment, preferably, the line space indications 160 are different in form (shape, pattern, color, size, etc.) from the image formation position indicator 120 so that the user can easily distinguish the line space indications 160 from the image formation position indicator 120. In the present embodiment, the line space indications 160 are triangular marks similar to the image formation position indicator 120, but the color thereof is different from the color of the image formation position indicator 120. Specifically, for example, while the image formation position indicator 120 is black, the line space indications 160 are white.

Further, the orthogonal-direction positioning member 101 according to the present embodiment includes an image formation start position indicator 140. When the handheld printer 1 is positioned at a predetermined scanning start position (home position) in the scanning direction, the image formation start position indicator 140 points at a start position of image formation on the recording medium by the handheld printer 1. With this structure, the user can grasp the position on a paper sheet at which the image formation starts in the scanning direction (X direction) and the portion of the sheet in which the image is to be formed. In the present embodiment, the image formation start position indicator 140 is provided with a letter image (an indication) of “print start”. With the indication, the user can recognize that the arrow representing the image formation start position indicator 140 points at the position at which the image formation starts.

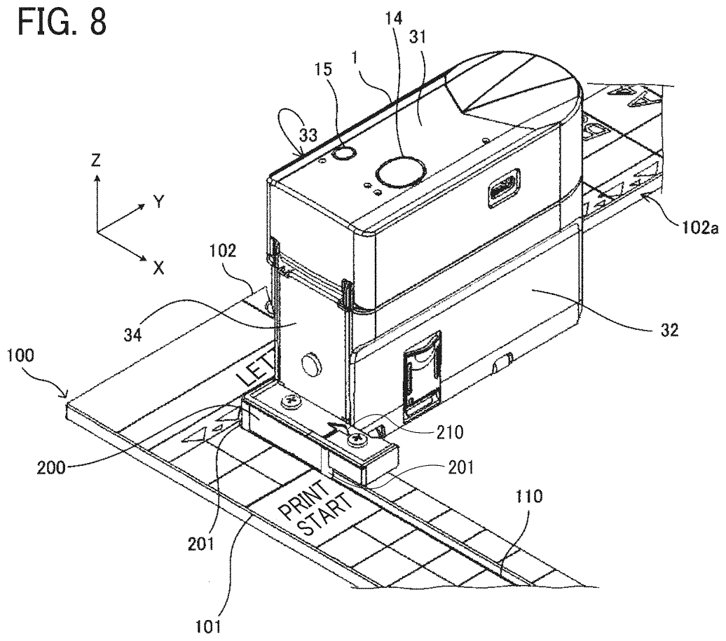

FIG. 8 is a schematic view illustrating the handheld printer 1 positioned at the scanning start position (home position) in the scanning direction with respect to the jig 100.

In the present embodiment, as the right side 33 of the handheld printer 1 is set in contact with an inner end face 102a (an end face on the lower side in FIG. 7) of the sheet positioning reference member 102 of the jig 100, the handheld printer 1 is positioned at the predetermined scanning start position (home position) in the scanning direction. A projection 201 (the inserted portion) is a portion of an attachment 200, which is a separate component attached to the handheld printer 1. At this time, if the projection 201 is set in the groove 110 of the jig 100, the image formation start position indicator 140 is hidden by the attachment 200 and is not visible to the user.

Therefore, in the present embodiment, an image formation start position indicator 210 is provided on the attachment 200 of the handheld printer 1. In the example illustrated in FIG. 8, the image formation start position indicator 210 is an arrow marking, but the shape, the method of marking, and the like are not particularly limited. In the present embodiment, when the handheld printer 1 is set at the home position, the image formation start position indicator 140 of the jig 100 is positioned at the same position in the scanning direction as the image formation start position indicator 210 of the attachment 200 attached to the handheld printer 1.

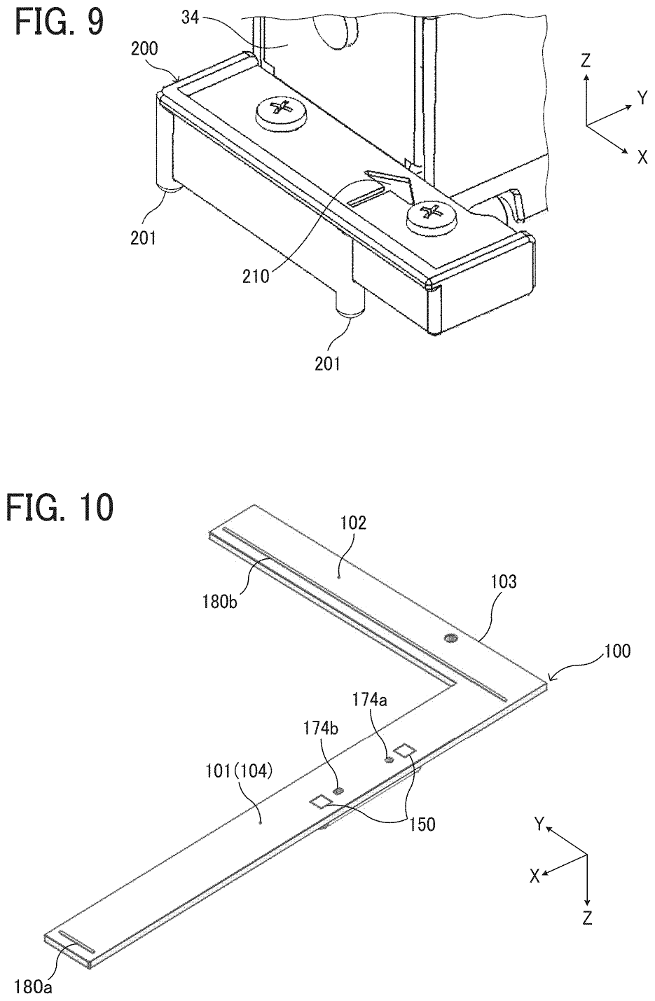

FIG. 9 is an enlarged view illustrating the attachment 200 attached to the handheld printer 1.

In the present embodiment, the projection 201 is provided to the attachment 200 attached to the handheld printer 1. The projection 201 is the inserted portion contacted by (abuts on) the inner wall face of the groove 110 from both sides in the orthogonal direction when the projection 201 is inserted in the groove 110 of the jig 100. With this structure, the displacements of the handheld printer 1 including the projection 201 to both sides in the orthogonal direction are restricted.

In the present embodiment, a plurality of projections 201 is disposed at the same position in the orthogonal direction and different positions from each other in the scanning direction. As the plurality of projections 201 enter the groove 110, the handheld printer 1 is inhibited from rotating around the Z direction, thereby stabilizing the posture of the handheld printer 1 when the handheld printer 1 is manually moved for scanning in the scanning direction (X direction). Thus, high-quality images can be formed.

The projections 201 according to the present embodiment are provided to the attachment 200 removably attached to the handheld printer 1. When an image is formed by the handheld printer 1 without using the jig 100, the projections 201 are unnecessary. Accordingly, in this case, the attachment 200 can be removed from the handheld printer 1. That is, the attachment 200 according to the present embodiment is used together with the jig 100. In image formation with the handheld printer 1 without the jig 100, the attachment 200 can be removed from the jig 100, thereby making the handheld printer 1 compact and facilitating the operability and handling of the handheld printer 1. In the present embodiment, the attachment 200 is not necessarily removable from the handheld printer 1.

FIG. 10 is a perspective view illustrating a bottom face 104 of the jig 100 in the present embodiment.

A first surface contact leg 180a as a protrusion portion is provided on the bottom face 104 of the orthogonal-direction positioning member 101 to face an upper side of a table on which a paper sheet is placed or the upper side of the paper sheet. Further, a second surface contact leg 180b as a protrusion portion is provided on the bottom face of the sheet positioning reference member 102. The first and second surface contact legs 180a and 180b are integrally molded with the base 103 as a single unit. The surface contact legs 180a and 180b extend in the orthogonal direction (Y direction). The first surface contact leg 180a is disposed at the end of the orthogonal-direction positioning member 101, opposite the sheet positioning reference member 102 in the scanning direction (X direction). The second surface contact legs 180b is disposed at a position closer to the end of the orthogonal-direction positioning member 101 of the sheet positioning reference member 102 extending in the orthogonal direction (Y direction).

Further, positioning holes 174a and 174b are disposed on the bottom face of the orthogonal-direction positioning member 101 to position the pressed portion 170. The high friction members 150 are disposed on the orthogonal-direction positioning member 101. The high friction members 150 have a higher friction coefficient with a paper sheet than the base 103.

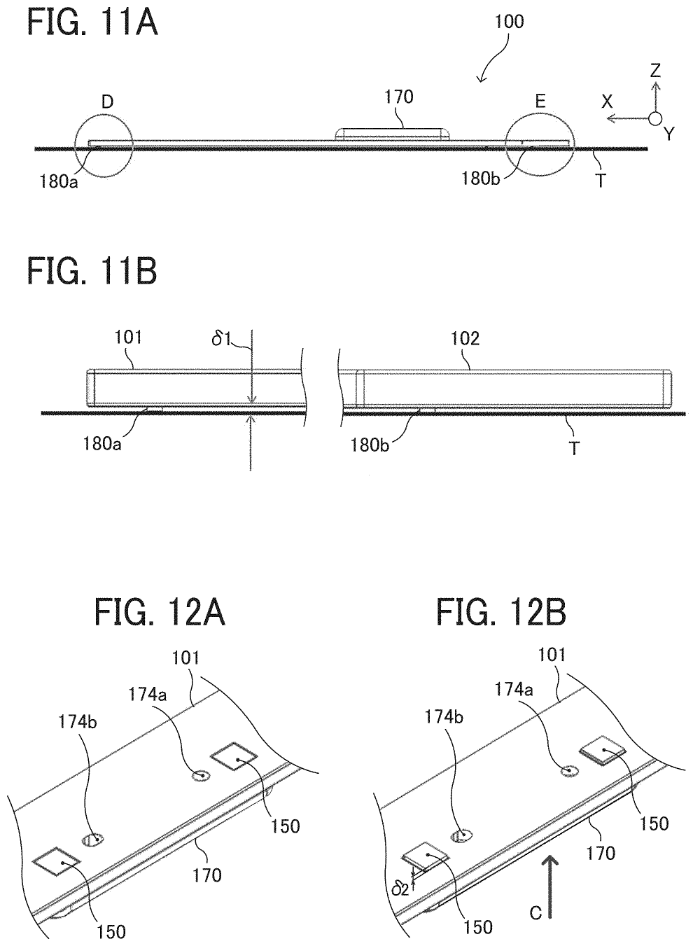

FIG. 11A is a side view of the jig 100 placed on a workbench T on which a paper sheet is placed according to the present embodiment; FIG. 11B is an enlarged view of a part D and part E of the FIG. 11A;

As illustrated in FIGS. 11A and 11B, when the jig 100 in the present embodiment is placed on a surface of the workbench T where a paper sheet is placed or on the upper side of the paper sheet, the first and second surface contact legs 180a and 180b contact the above-mentioned surface or the upper side of the paper sheet. As described above, in the present embodiment, as there is a gap distance δ1 with respect to the surface of the workbench T except for the surface contact legs 180a and 180b, the user can easily insert a paper sheet between the surface of the workbench T and the jig 100 placed on the workbench T.

The first surface contact leg 180a is disposed on the orthogonal-direction positioning member 101 at the opposite end of the sheet positioning reference member 102. Such a placement of the surface contact leg 180a at the end of the jig inhibits the surface contact leg 180a from contacting a paper sheet, and when adjusting the relative positions between the jig 100 and the paper sheet, rubbing on the paper sheet surface can be suppressed.

Further, in the present embodiment, the surface contact legs 180a and 180b are formed integrally with the base 103 as a single unit and are made of the same material as the base 103. However, the surface contact legs 180a and 180b can be formed with a material with a lower friction coefficient with a paper sheet than the material of the base 103. As described above, with the surface contact legs 180a and 180b being formed with the material with the lower friction coefficient than the base 103, the user can insert a paper sheet between the workbench and the jig 100 placed on the workbench T even more easily.

Since the surface contact legs 180a and 180b protrude by the gap distance δ1 from the bottom face of the base 103, the jig 100 is installed keeping the space from the surface of the workbench T by the amount of protrusion (height from the bottom) of the gap distance δ1. Further, the gap distance δ1 (the protrusion amount) is set to be larger than a thickness t of a paper sheet placed on the workbench T (δ1>t), and the jig 100 is installed with a space maintained from the upper side of the paper sheet placed on the surface of the workbench T.

FIG. 12A is an enlarged perspective view illustrating the positions of the high friction members 150 when the user does not push down the pressed portion 170 and FIG. 12B is an enlarged perspective view illustrating the positions of the high friction members 150 when the user pushes down the pressed portion 170.

As illustrated in FIG. 12A, when the user does not push down the pressed portion 170, the high friction members 150 are at a position retracted by about 0.1 to 1 mm from the bottom face of the orthogonal-direction positioning member 101. Owing to such mechanism, when the pressed portion 170 is not pressed, the high friction members 150 are not in contact with a paper sheet and the function of the high friction members 150 to prevent positional displacement is in non-operating state. Therefore, the jig 100 can be moved relative to the paper sheet by sliding on the paper sheet, and the jig 100 can be easily moved to a target position on the paper sheet for forming an image.

In the present embodiment, when the user does not push down the pressed portion 170, the high friction members 150 are at a position retracted by about 0.1 to 1 mm from the bottom face of the orthogonal-direction positioning member 101. In this case, the high friction members 150 are not in contact with a paper sheet and the function to prevent positional displacement from the paper sheet is in non-operating state. Therefore, the high friction members 150 may not be at the retracted position from the bottom face of the orthogonal-direction positioning member 101. In the jig 100 of the present embodiment, as mentioned above, the bottom face of the jig 100 floats from a paper sheet (by δ1−t). Therefore, in case the amount of protrusion of the high friction members 150 is less than (δ1−t) from the bottom face of the jig 100, when the user does not press down the pressed portion 170, the high friction members 150 do not contact the paper sheet and the positional displacement function can be disabled.

On the other hand, as illustrated in FIG. 12B, when the user pushes down the pressed portion 170 as indicated by arrow C, the high friction members 150 protrude by a protrusion amount δ2 from the bottom face of the orthogonal-direction positioning member 101 and contact the paper sheet. The protrusion amount δ2 of the high friction members 150 is equal to or more than the difference between the protrusion amount δ1 of the surface contact legs 180a and 180b from the bottom face of the base 103 and the thickness t of a paper sheet (δ2≥(δ1−t)). In this way, when the user pushes down the pressed portion 170, the high friction members 150 contact the paper sheet and the positional displacement function is activated. Thus, the relative positional displacement between the paper sheet and the jig 100 can be reduced.

Next, the switching mechanism for switching the positional displacement prevention function between the non-operating state and the operating state is described.

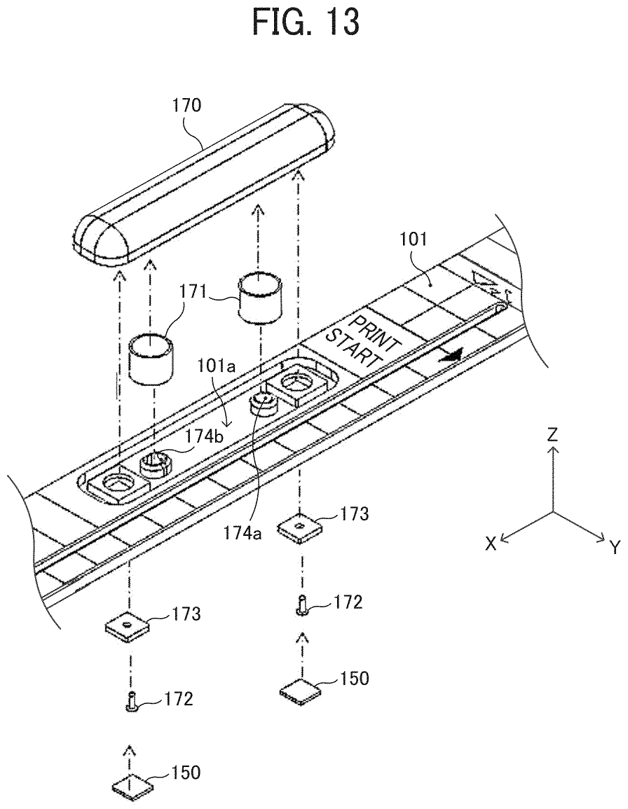

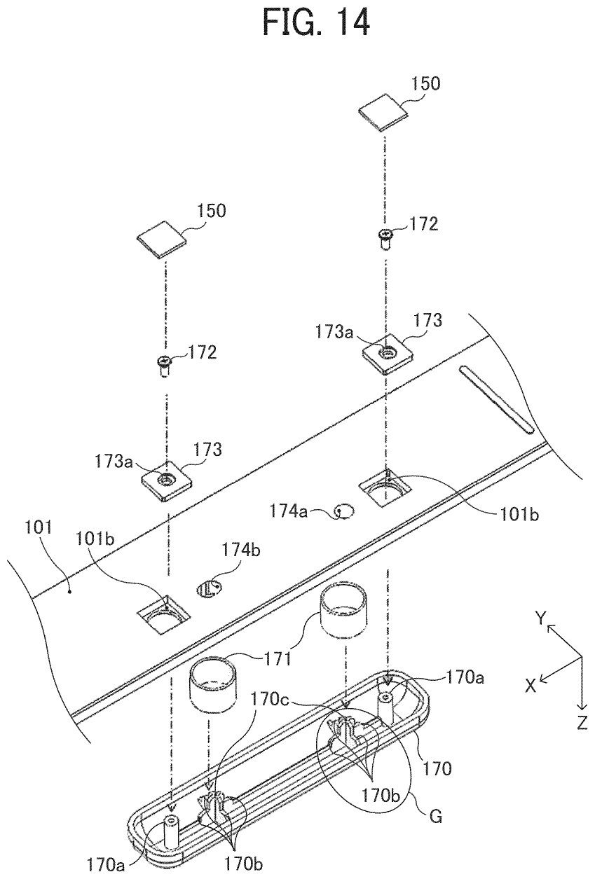

FIG. 13 is an exploded perspective view illustrating a main section of the jig; FIG. 14 is an exploded perspective view of the bottom face of the jig; FIG. 15 is an enlarged view of a part G of FIG. 14.

Further, as illustrated in FIG. 13, the orthogonal-direction positioning member 101 includes a storage recess 101a that houses the pressed portion 170.

Compression coil springs 171 as biasing members are disposed between the pressed portion 170 and the storage recess 101a. Further, the storage recess 101a includes two positioning holes 174a and 174b to position the pressed portion 170 onto the orthogonal-direction positioning member 101 (base 103). The positioning hole 174a closer to the sheet positioning reference member 102 is a main reference for positioning and is a round hole. The other positioning hole 174b is a sub reference for positioning and is an elongated hole extending in the main scanning direction.

As illustrated in FIG. 14, the pressed portion 170 includes screw boss portions 170a in the vicinity of both ends in the scanning direction (X direction) on the back side of the pressed portion 170 and screw holes are formed at the respective centers of the screw boss portions 170a. Further, on the inner side of the screw boss portions 170a in the scanning direction, two cross-shaped spring holding portions 170b for holding the compression coil springs 171 are provided at predetermined intervals in the scanning direction. The diameter of a circle connecting the ends of the cross-shape of the cross-shaped spring holding portions 170b is set to be slightly larger than the inner diameter of the compression coil springs 171, and the compression coil springs 171 are fitted with pressure into the cross-shaped spring holding portions 170b.

Further, cross-shaped positioning portions 170c smaller than the cross-shaped spring holding portions 170b are respectively provided so as to be stacked on the cross-shaped spring holding portions 170b (see FIGS. 14 and 15).

Further, as illustrated in FIG. 14, on the bottom face of the orthogonal-direction positioning member 101, two fixing member storage recesses 101b are provided at predetermined intervals in the scanning direction. The fixing member storage recesses 101b house fixing members 173 which secure the pressed portion 170 to the orthogonal-direction positioning member 101. Each fixing member 173 stored in the fixing member storage recess 101a is formed with a through-hole through which a screw 172 passes, and a screw storage recess 173a in which the head of the screw 172 is stored. The depth of the screw storage recesses 173a is longer than the thickness of the screw head of the screws 172, so that after screwing, the screw heads do not protrude from the surface to which the high friction members 150 of the fixing members 173 are attached.

In the present embodiment, the depth of the fixing member storage recesses 101b is 0.1 to 1 mm deeper than the sum of the thickness of the fixing members 173 and the high friction members 150. Owing to this structure, as illustrated in FIG. 12A, when the user does not push down the pressed portion 170, the high friction members 150 are at a position retracted by about 0.1 to 1 mm from the bottom face of the orthogonal-direction positioning member 101.

The high friction members 150 are made of foamed urethane rubber, polyester film, silicon, or the like and are attached to the fixing members 173 with double-sided adhesive tape or the like. In the present embodiment, although urethane foam rubber is used for the high friction members 150, any material having a larger friction coefficient with a paper sheet than the base 103 or the surface contact legs 180a and 180b may be used.

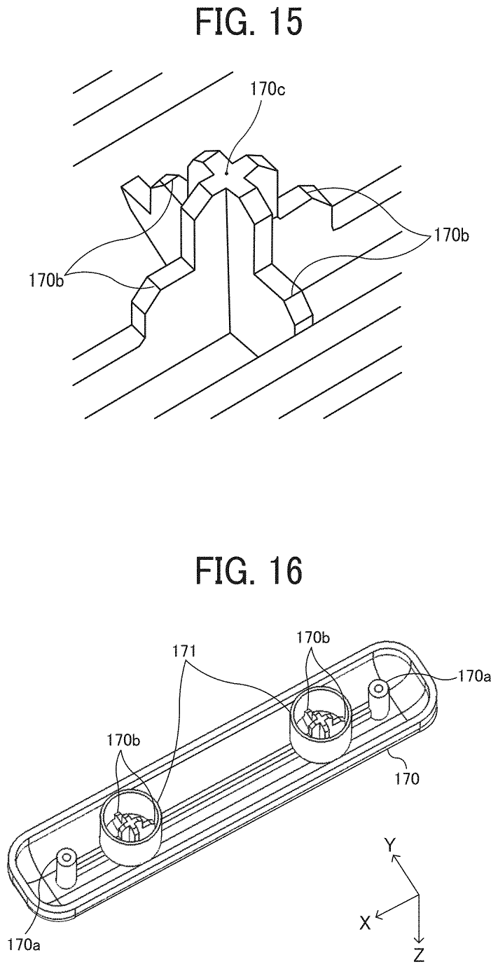

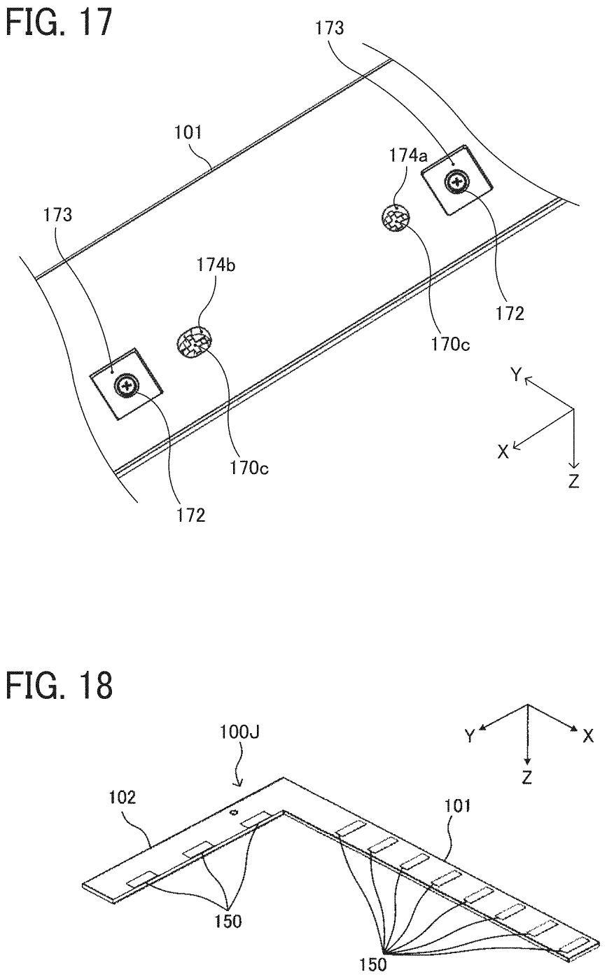

FIG. 16 is a view illustrating a state when the compression coil springs 171 are attached to the pressed portion 170 and FIG. 17 is an enlarged perspective view illustrating a state where the pressed portion 170 is attached to the orthogonal-direction positioning member 101.

As illustrated in FIG. 16, first, the compression coil springs 171 are fitted with the cross-shaped spring holding portions 170b of the pressed portion 170, and thus the compression coil springs 171 are held by the pressed portion 170. As described above, since the compression coil springs 171 are held on the pressed portion 170, the compression coil springs 171 can be prevented from falling out from the pressed portion 170 at the time of assembling, thereby facilitating the assembling.

Next, the pressed portion 170 is inserted into the storage recess 101a of the orthogonal-direction positioning member 101. At this time, each of the cross-shaped positioning portions 170c are inserted into the positioning holes 174a and 174b respectively, thus positioning the pressed portion 170 with respect to the orthogonal-direction positioning member 101 (base 103).

Next, the fixing members 173 are inserted into the fixing member storage recesses 101a from the bottom side of the orthogonal-direction positioning member 101. As described above, since the position of the pressed portion 170 is determined, the screw holes of the screw boss portions 170a of the pressed portion 170 and the through-holes of the fixing members 173 are aligned in a straight line in the height direction (Z direction). As a result, the screws 172 can be easily screwed into the screw holes of the screw boss portions 170a.

As the screws 172 are screwed into the screw holes of the screw boss portions 170a, the compression coil springs 171 are compressed to bias the pressed portion 170. Then, as the heads of screws 172 fit into the screw storage recesses 173a of the fixing members 173, the pressed portion 170 is attached to the orthogonal-direction positioning member 101.

In the present embodiment, the fixing members 173 include the screw storage recesses 173a to store screw heads, so that the screw heads do not protrude from the surface to which the high friction members 150 of the fixing members 173 are attached. Owing to this structure, the high friction members 150 can be firmly attached to the fixing members 173 without floating.

In the jig 100 according to the present embodiment, with such a configuration, when the user does not push down the pressed portion 170, that is, when the user does not operate the pressed portion 170, the pressed portion 170 is biased by the compression coil springs 171 in the +Z direction (the direction in which the pressed portion 170 come out from the storage recess 101a). At this time, the fixing members 173 hit the bottom face of the fixing member storage recesses 101b, inhibiting the pressed portion 170 from coming out from the storage recess 101a. Also, at this time, as illustrated in FIG. 12A, the high friction members 150 are retracted from the bottom face of the orthogonal-direction positioning member 101 and are in contactless state with a paper sheet. Thus, the function of the high friction members 150 to prevent positional displacement from the paper sheet is in non-operating state.

On the other hand, when the user pushes down the pressed portion 170, the pressed portion 170 moves against the biasing force of the compression coil springs 171 and moves in the −Z direction (the direction in which the pressed portion 170 fits in the storage recess 101a). As a result, the high friction members 150 attached to the fixing members 173 screwed to the pressed portion 170 move together with the pressed portion 170 in the −Z direction (the direction in which the high friction members 150 come out of the fixing member storage recesses 101b), and the high friction members 150 pop out from the bottom of the orthogonal-direction positioning member 101. Then, as the lower end of the pressed portion 170 hits the bottom face of the storage recess 101a, the movement of the pressed portion 170 in the −Z direction is restricted. At this time, as illustrated in FIG. 12B, the high friction members 150 pop out from the bottom of the orthogonal-direction positioning member 101 by the gap distance δ2 and contact the upper side of a paper sheet. As a result, the function of the high friction members 150 to prevent positional displacement from the paper sheet is activated.

When the user releases the hand from the pressed portion 170, the pressed portion 170 moves by the biasing force of the compression coil springs 171 in the +Z direction and returns to a state as illustrated in FIG. 12A automatically.

In the present embodiment, the compression coil springs 171 bias the pressed portion 170 in the +Z direction (the direction in which the pressed portion 170 comes out from the storage recess 101a), but any biasing member such as a helical tension spring or a flat spring that performs the same function may be used.

In a case where the pressed portion 170 has a backlash in the direction orthogonal to the pressing direction with respect to the jig 100, when the pressed portion 170 moves in the direction orthogonal to the pressing direction with respect to the jig 100 while the high friction members 150 are in contact with the paper sheet, the paper sheet undesirably moves in the same direction similarly and the relative positional relationship between the paper sheet and the jig 100 may be shifted.

On the contrary, in the present embodiment, the cross-shaped positioning portions 170c of the pressed portion 170 is fitted into the positioning holes 174a and 174b, and the movement of the pressed portion 170 in the direction orthogonal to the pressing direction (Z direction) is restricted by the positioning holes 174a and 174b. Such a structure can prevent the paper sheet from moving with the pressed portion 170 while the high friction members 150 are in contact with the paper sheet and prevent the relative positional relationship between the paper sheet and the jig 100 from being shifted.

FIG. 18 is a perspective view illustrating the bottom face of a jig 100J according to a comparative example.

A plurality of high friction members 150 are attached to the bottom of the jig 100J according to the comparative example. In such a configuration, the high friction members 150 always contact a paper sheet in a state where the jig 100J is installed on the paper sheet, and the operation state of the sheet positional displacement prevention is not deactivated unless the jig 100J is lifted. Therefore, in such a comparative configuration, even if the user slides the jig 100J on the paper sheet to move the jig 100J to a predetermined target position on the paper sheet, the paper sheet, and the jig 100J move together by the frictional force of the high friction members 150. That is, sliding the jig 100J on the paper sheet is difficult. As a result, the user needs to lift the jig 100J to move the jig 100J to the target position as mentioned above, and the user cannot move the jig 100J quickly to the target position.

In addition, each time the user adjusts the position of the jig 100J with respect to the paper sheet, the user needs to lift the jig 100J and it takes time to adjust the position of the jig 100J with respect to the paper sheet.

On the contrary, in the present embodiment, when the user does not push down the pressed portion 170, the high friction members 150 are retreated from the bottom face of the jig 100 (base 103) and the high friction members 150 are not in contact with a paper sheet. Therefore, at this time, the function of the high friction members 150 to prevent positional displacement from the paper sheet is not in operation. As a result, the user can move the jig 100 by sliding the jig 100 on the paper sheet. Compared to the case where the user needs to lift the jig 100J from the paper sheet to move the jig 100J, the user can easily move the jig 100 to a predetermined target position on the paper sheet.

In addition, when adjusting the position of the jig 100 with respect to the paper sheet, the user can adjust the position of the jig 100 by sliding the jig 100 on the paper sheet. As a result, compared with the case where the user needs to adjust the position of the jig 100 by lifting the jig in each adjustment, the user can quickly adjust the position of the jig 100 with respect to the paper sheet.

Also, in the present embodiment, as illustrated in FIG. 10 and FIGS. 11A to 11B, the surface contact legs 180a and 180b are provided on the bottom face of the jig 100, and there is the gap distance δ1 between the jig 100 and the paper sheet or the surface of the workbench T except where the surface contact legs 180a and 180b are positioned. Therefore, when the user moves the jig 100 by sliding the jig 100 on the paper sheet or the surface of the workbench T relative to the paper sheet, the above-mentioned surface contact legs 180a and 180b slide on the paper sheet. As a result, with the surface contact legs 180a and 180b being formed with a material with a lower friction coefficient with respect to a paper sheet than the base 103, the sliding resistance between the surface contact legs 180a and 180b and the paper sheet can be reduced. Such a mechanism can further restrain the paper sheet from moving with the jig 100 when the user moves the jig 100 by sliding the jig 100 on the paper sheet relative to the paper sheet.

In addition, as in the present embodiment, with the surface contact legs 180a and 180b molded with the base 103 as a single unit, the production cost can be reduced compared with a case where the surface contact legs 180a and 180b are formed with a material with a lower friction coefficient with respect to a paper sheet than that of the base 103, thereby making it possible to provide the jig 100 at a low cost.

Also, when the jig 100 is positioned at a desired location on a paper sheet and the handheld printer 1 forms an image on the paper sheet, the user pushes down the pressed portion 170 to cause the high friction members 150 to project from the bottom face of the jig 100 (base 103) and contact the paper sheet. As a result, the function of the high friction members 150 to prevent positional displacement from the paper sheet is activated to prevent positional displacement during image formation as the paper sheet moves. Thus, image can be formed at a desired position on the paper sheet.

Detailed description of the image formation process using the jig 100 according to the present embodiment is given below.

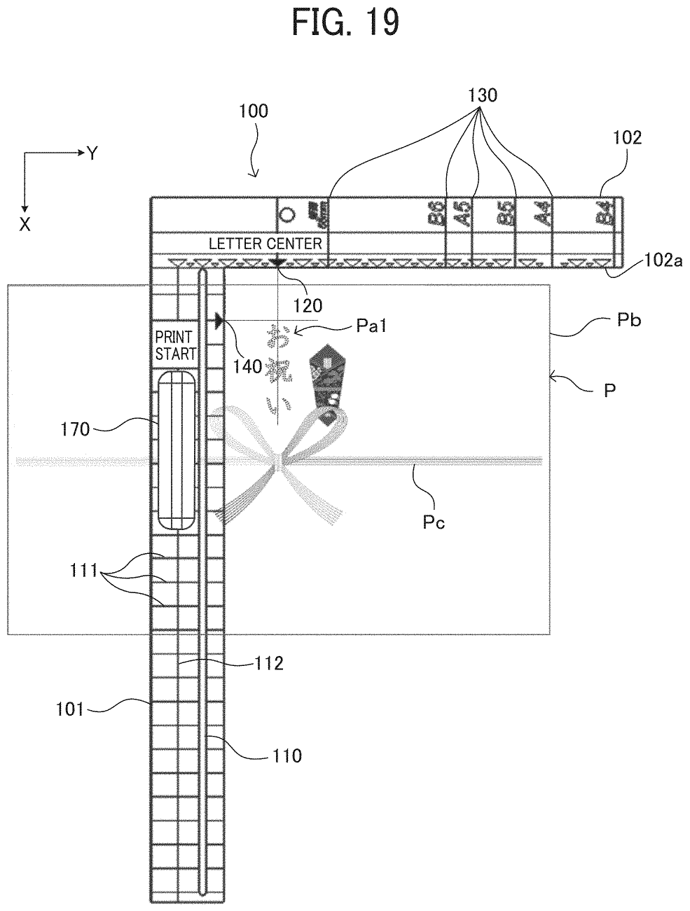

FIG. 19 is a plan view illustrating the jig 100 according to the present embodiment placed on an A4-sized wrapping sheet P on which a gift ribbon is printed and the handheld printer 1 forming a letter image representing an occasion type or a sender name.

First, the user places the jig 100 on the wrapping sheet P placed on the workbench, as illustrated in FIG. 19. Alternatively, the wrapping sheet P is placed on the workbench so as to be inserted between the jig 100 placed on the workbench and the workbench. In the present embodiment, as illustrated in FIG. 10, FIGS. 11A and 11B, the surface contact legs 180a and 180b are provided on the bottom face of the jig 100, and there is the gap distance δ1 between the jig 100 and the paper sheet or the surface of the workbench except where the surface contact legs 180a and 180b are positioned. As a result, the user can easily insert the wrapping sheet P in between the surface of the workbench and the jig 100 placed on the workbench.

Next, the user adjusts the relative positions of the jig 100 and the wrapping sheet P so that an upper end of the letter image Pa1 (the image formation start position) representing an occasion type “congratulations” to be formed on the wrapping sheet P matches the image formation start position indicator 140 in the scanning direction.

Further, the user adjusts the relative positions of the jig 100 and the wrapping sheet P so that the A4-size sheet end indication 130 on the sheet positioning reference member 102 of the jig 100 matches an end Pb of the wrapping sheet P in the orthogonal direction. With such setting, the center position of the letter image Pal to be formed on the wrapping sheet P matches the orthogonal direction position indicated by the image formation position indicator 120 formed on the sheet positioning reference member 102 of the jig 100.

Furthermore, the user adjusts the relative positions of the jig 100 and the wrapping sheet P such that the end Pb of the wrapping sheet P in the orthogonal direction is parallel to the scanning direction (X direction). There are various methods of such adjustment. For example, as the direction of the gift ribbon image Pc printed on the wrapping sheet P extends in the direction orthogonal to the end Pb in the orthogonal direction of the wrapping sheet P, the relative positions of the jig 100 and the wrapping sheet P can be adjusted so that the gift ribbon image Pc is parallel to the sheet reference lines 111 on the orthogonal-direction positioning member 101 of the jig 100. Alternatively, one end (for example, the upper end in FIGS. 12A and 12B) of the wrapping sheet P in the scanning direction extends in the direction orthogonal to the end Pb of the wrapping sheet P and the inner end face 102a of the sheet positioning reference member 102 of the jig 100 is parallel to the orthogonal direction, the relative positions of the jig 100 and the wrapping sheet P can be adjusted so that the upper end of the wrapping sheet P is parallel to the inner end face 102a of the sheet positioning reference member 102 of the jig 100.

In the present embodiment, at the time of adjusting the relative positions between the jig 100 and the wrapping sheet P as described above, the pressed portion 170 is not pressed, and the high friction members 150 are at the retracted position (non-contact with the wrapping sheet P) and the positional displacement prevention function is in a non-operating state. Therefore, the wrapping sheet P can be moved relative to the jig 100 without lifting the jig 100, and the relative positions of the jig 100 and the wrapping sheet P can be quickly adjusted.

In addition, as illustrated in FIG. 19, the wrapping sheet P does not face the sheet positioning reference member 102 and does not contact the second surface contact leg 180b (see FIG. 10) provided on the sheet positioning reference member 102. In addition, as can be seen from FIG. 19, the length of the wrapping sheet P in the scanning direction (X direction) is shorter than that of the orthogonal-direction positioning member 101. As a result, the wrapping sheet P is not in contact with the first surface contact leg 180a disposed at the end of the orthogonal-direction positioning member 101 opposite to the sheet positioning reference member 102. Therefore, in the example illustrated in FIG. 19, the wrapping sheet P and the jig 100 do not rub against each other and the relative positions of the wrapping sheet P and the jig 100 can be adjusted.

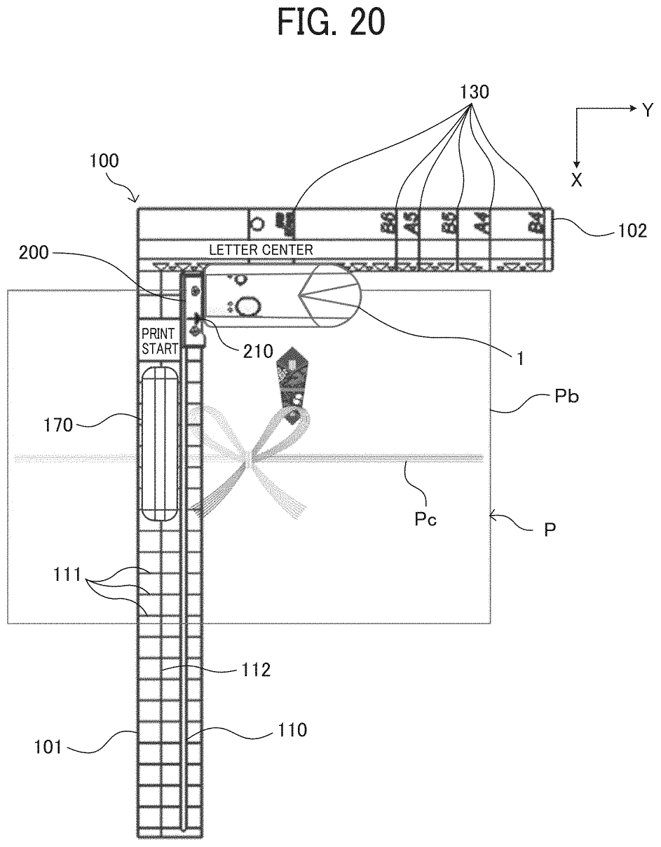

After thus adjusting the relative positions between the jig 100 and the wrapping sheet P, the user pushes down the pressed portion 170 with one hand. Then, the high friction members 150 move to the contact position where the high friction members 150 contact the wrapping sheet P, and the paper sheet positional displacement prevention function is activated. Then, the user pushes down the pressed portion 170 with one hand and holds the handheld printer 1 with the other hand. As illustrated in FIG. 20, the user sets the handheld printer 1 on the jig 100 so that the projections 201 (see FIG. 8) of the attachment 200 of the handheld printer 1 enter the groove 110 formed in the orthogonal-direction positioning member 101 of the jig 100. As a result, the handheld printer 1 can move freely in the scanning direction (X direction) while the position in the orthogonal direction (Y direction) is regulated.

After thus setting the handheld printer 1 on the jig 100, the user abuts the right side 33 of the handheld printer 1 against the inner end face 102a (the lower end face in FIG. 7) of the sheet positioning reference member 102 of the jig 100. Then, the position of the handheld printer 1 in the scanning direction is determined at the predetermined scanning start position (home position). That is, the inner end face 102a (the lower end face in FIG. 7) of the sheet positioning reference member 102 of the jig 100 serves as a scanning start positioning reference for setting the position of the handheld printer 1 at the scanning start position from which scanning with the handheld printer 1 is started.

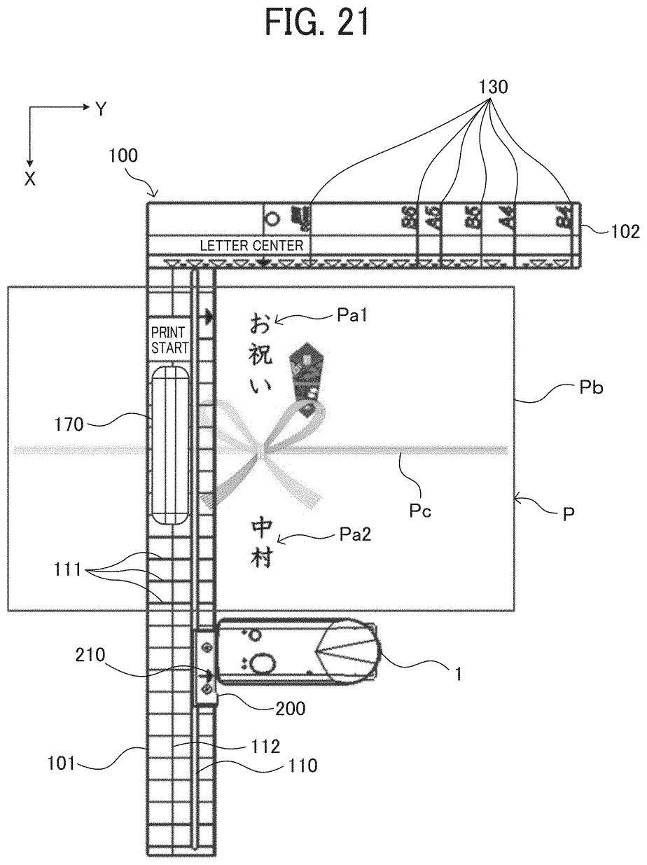

After the handheld printer 1 is set at the home position as described above, the user presses the print button 14 and moves the handheld printer 1 (manual scanning) in the scanning direction (X direction) so that the projections 201 of the handheld printer 1 move along the groove 110 of the jig 100. As a result, as illustrated in FIG. 21, the letter image Pal representing an occasion type (congratulations) and subsequently the letter image Pa2 representing a sender name are formed at the center (target position) of the wrapping sheet P in the orthogonal direction. In the case of images to be formed at the same position of the wrapping sheet P in the orthogonal direction as illustrated in FIG. 21, such as the letter images Pa1 and Pa2, the images can be formed in one manual scanning.

In a series of operations performed after adjusting the relative positions between the jig 100, the user keeps pressing down the pressed portion 170 to keep the high friction members 150 in contact with the wrapping sheet P, and the positional displacement prevention function of the high friction members 150 is in an operating state. Thus, the wrapping sheet P does not move with respect to the jig 100 and the letter images Pa1 and Pa2 are formed at a desired position on the wrapping sheet P.

Next, descriptions are given below of a procedure for forming an image with a plurality of times of manual scanning with the handheld printer 1 on one paper sheet, using the jig 100.

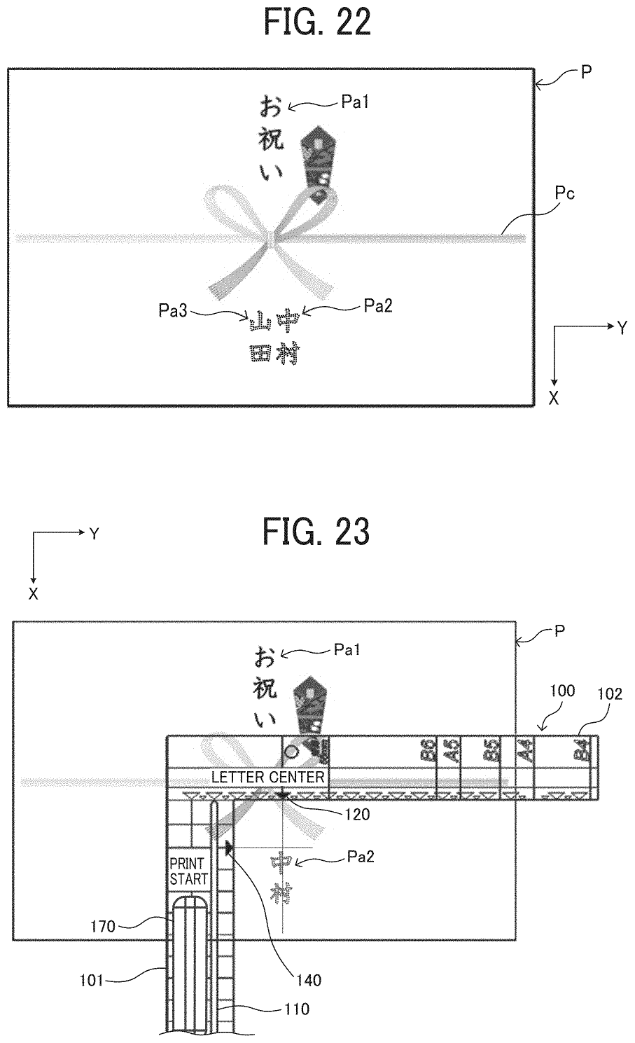

FIG. 22 illustrates the case where, after the letter image Pa1 representing the occasion type is formed on the wrapping sheet P, the letter images Pa2 and Pa3 representing names of two senders are formed in two lines in the orthogonal direction.

As illustrated in FIG. 22, both the letter images Pa2 and Pa3 representing the two sender names are to be formed at positions shifted from the center of the wrapping sheet P in the orthogonal direction. As described above, according to the present embodiment, the sheet end indications 130 are designed as follows. When the handheld printer 1 set at the home position is manually moved for scanning for image formation in a state in which the A4-sized sheet end indication 130 on the jig 100 is aligned with one end of the A4-sized wrapping sheet P in the orthogonal direction, the image is formed with the image center positioned at the center of the wrapping sheet P in the orthogonal direction. Therefore, if one end of the wrapping sheet P in the orthogonal direction is aligned with the sheet end indication 130, the letter images Pa2 and Pa3 representing the two sender names are not formed at the respective target positions on the wrapping sheet P.

In such a case, the user removes the handheld printer 1 from the jig 100 after the handheld printer 1 forms the letter image Pal on the wrapping sheet P. Then, in a state where the pressed portion 170 is not pressed, the user slides the jig 100 on the wrapping sheet P. Next, as illustrated in FIG. 23, the user adjusts the relative positions of the jig 100 and the wrapping sheet P so that an upper end (the image formation start position) of the letter images Pa2 and Pa3 to be formed in two lines on the wrapping sheet P matches the image formation start position indicator 140 in the scanning direction. In addition, as illustrated in FIG. 23, the user slides the jig 100 on the wrapping sheet P and adjusts the relative positions between the jig 100 and the wrapping sheet P so that the image formation position indicator 120 on the sheet positioning reference member 102 of the jig 100 matches the target position image formation position (in the orthogonal direction) of the letter image Pa2, which is one of the two letter images Pa2 and Pa3, to be formed on the wrapping sheet P in two lines.

Furthermore, after the user adjusts the relative positions of the jig 100 and the wrapping sheet P such that the end Pb of the wrapping sheet P in the orthogonal direction is parallel to the scanning direction (X direction), the user pushes down the pressed portion 170 with one hand and activates the positional displacement prevention function of the high friction members 150. Then, the user sets the handheld printer 1 relative to the jig 100, with the projections 201 of the attachment 200 of the handheld printer 1 inserted in the groove 110 of the jig 100, and positions the handheld printer 1 at the predetermined scanning start position (home position) in the scanning direction. Then, the user presses the print button 14 and moves the handheld printer 1 (manual scanning) in the scanning direction (X direction) so that the projections 201 of the handheld printer 1 move along the groove 110 of the jig 100. Thus, the letter image Pa2 representing the name of a sender on the first line is formed at the target position of the wrapping sheet P.

As described above, the letter image Pa2 representing the sender name is formed on the first line. Then, the user stops pressing down the pressed portion 170 and deactivates the positional displacement prevention function of the high friction members 150 and slides the jig 100 on the wrapping sheet P and adjusts again the relative positions between the jig 100 and the wrapping sheet P to form the letter image Pa3 representing the sender name on the second line.

Further, the sheet positioning reference member 102 of the jig 100 according to the present embodiment includes the line space indications 160 disposed at regular intervals from the image formation position indicator 120 in the orthogonal direction. Specifically, the line space indications 160 are disposed at intervals equivalent to one line space when an image of one line is formed in one scanning. The line space indications 160 are respectively disposed at different positions in the orthogonal direction on the sheet positioning reference member 102. Providing the line space indications 160 on the jig 100 is advantageous when an image extending over a plurality of lines is formed. Since the user is given a guide for distance between lines, the image extending over a plurality of lines can be easily formed with constant line spaces.

The distance between the lines indicated by the line space indications 160 for determining the position in the orthogonal direction can be suitably set in accordance with the specifications of the handheld printer 1 (maximum image length formable by the handheld printer 1 in the orthogonal direction, etc.) or the manner of use by the user (letter image size used by the user). In the jig 100 according to the present embodiment, one line space is set to the length of the recording section 41 of the inkjet head 40 of the handheld printer 1 in the orthogonal direction, and the respective positions of the line space indications 160 in the orthogonal direction are determined accordingly. With such a configuration, when an image extending over a plurality of lines is formed with reference to the line space indications 160, overlapping of the adjacent lines in the image can be avoided.

In addition, setting the line space to the length of the recording section 41 in the orthogonal direction as described above is advantageous when a plurality of partial images extending over a plurality of lines is formed on a paper sheet with image formation of the maximum length in the orthogonal direction of the handheld printer 1 and combined into one image. In this case, displacements among the partial images in the orthogonal direction can be reduced, and the quality of the combined image can be high.

Further, in the jig 100 according to the present embodiment, auxiliary indications 161 smaller than the line space indications 160 are respectively disposed between the adjacent line space indications 160. This configuration is advantageous when the user wants to form an image extending over a plurality of lines with line spacing different from the line spacing indicated by the line space indications 160. The user can adjust the relative positions between the jig 100 and a wrapping sheet P with reference also to the auxiliary indications 161 so that the target line spacing is achieved. Therefore, even in the case of image formation over a plurality of lines with line spacing different from the spacing indicated by the line space indications 160, an image extending over a plurality of lines can be easily formed with constant line spacing.

Further, in the present embodiment, preferably, the line space indications 160 are different in form (shape, pattern, color, size, etc.) from the image formation position indicator 120 so that the user can easily distinguish the line space indications 160 from the image formation position indicator 120. In the present embodiment, the line space indications 160 are triangular marks similar to the image formation position indicator 120, but the color thereof is different from the color of the image formation position indicator 120. Specifically, for example, while the image formation position indicator 120 is black, the line space indications 160 are white.

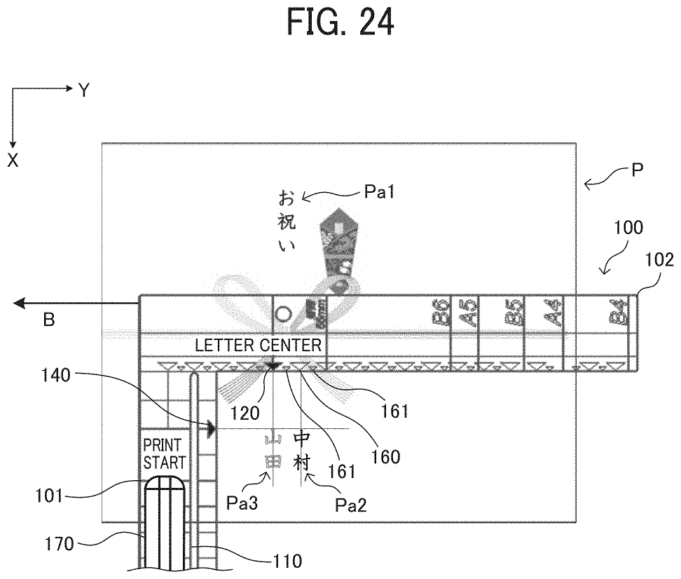

When the user forms the letter image Pa3 representing the sender name on the second line, the user adjusts again the relative positions between the jig 100 and the wrapping sheet P so that the center of the already-formed letter image Pa2 (the sender name on the first line) in the orthogonal direction is aligned with the position indicated by the line space indication 160 adjacent to the image formation position indicator 120. Specifically, the user slides the jig 100 on the wrapping sheet P in the direction indicated by arrow B in FIG. 24 with the wrapping sheet P fixed in position so that the center in the orthogonal direction of the letter image Pa2 representing the sender name on the first line matches the position indicated by the line space indication 160 next to the image formation position indicator 120. With this operation, as illustrated in FIG. 24, the relative positions between the jig 100 and the wrapping sheet P are adjusted so that the image formation position indicator 120 on the sheet positioning reference member 102 of the jig 100 matches the target position (in the orthogonal direction) at which the letter image Pa3 representing the sender name on the second line is to be formed on the wrapping sheet P.

Then, in the same manner as described above, the user pushes down the pressed portion 170 and activates the function of the high friction members 150 to prevent positional displacement from the paper sheet. In the present embodiment, the pressed portion 170 is provided in the vicinity of the image formation start position indicator 140, and the high friction members 150 are provided near both ends in the scanning direction (X direction) of the pressed portion 170 (See FIG. 13 and FIG. 14). Therefore, as illustrated in FIG. 24, even when the pressed portion 170 faces only a part of the wrapping sheet P, when the pressed portion 170 is pushed down, the high friction member 150 (the high friction member on the right side of FIG. 13) provided near the end of the image formation start position indicator 140 contacts the wrapping sheet P and can perform the positional displacement prevention.

Then, the user sets again the handheld printer 1 relative to the jig 100, with the projections 201 of the attachment 200 of the handheld printer 1 inserted in the groove 110 of the jig 100 and positions the handheld printer 1 at the predetermined scanning start position (home position) in the scanning direction. Then, the user presses the print button 14 and moves the handheld printer 1 (manual scanning) in the scanning direction (X direction) so that the projections 201 of the handheld printer 1 move along the groove 110 of the jig 100. Thus, the letter image Pa3 representing the name of the sender on the second line is formed at the target position of the wrapping sheet P.

Next, a variation of the jig 100 is described.

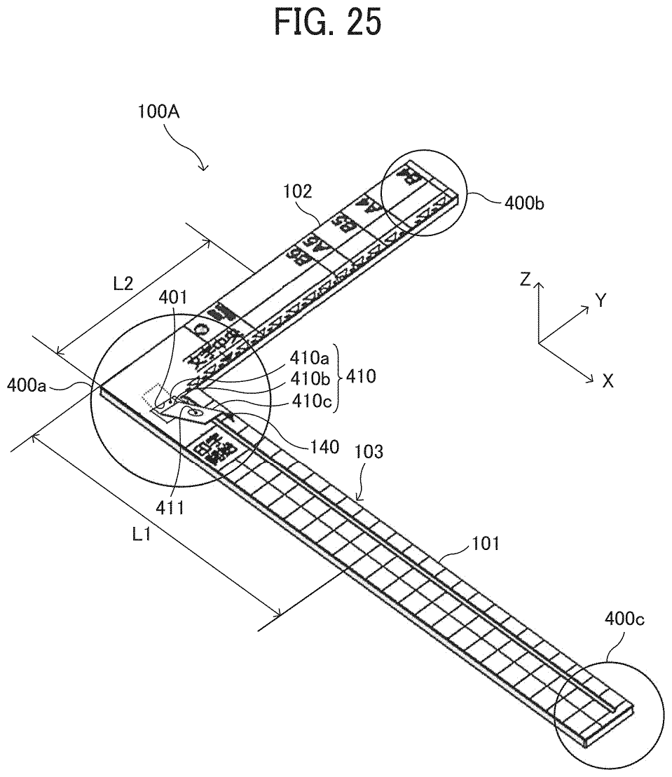

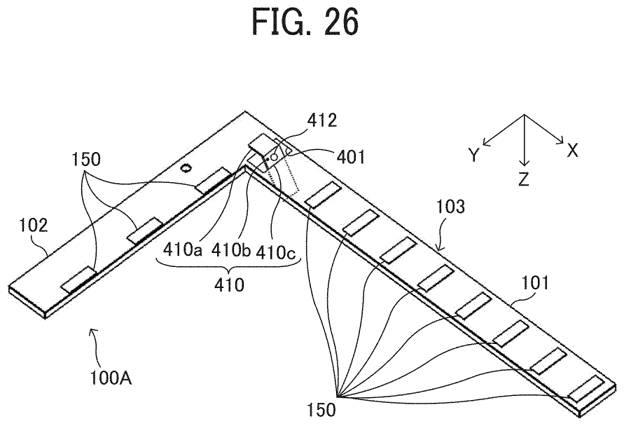

FIG. 25 is a perspective view of a jig 100A, according to the variation, as viewed from obliquely above and FIG. 26 is a perspective view of the bottom face of the jig 100A according to the variation.

In this variation, unlike the jig according to the above-mentioned embodiment, when the user pushes down the pressed portion 170, the high friction members 150 are separated from a paper sheet and the function of the high friction members 150 to prevent positional displacement from the paper sheet is in non-operating state.

In the variation, instead of the pressed portion 170, the jig 100A includes a pressed flat spring 410. A through-hole 401 through which the pressed flat spring 410 penetrates is formed at a position closer to the sheet positioning reference member 102 than the image formation start position indicator 140 on the orthogonal-direction positioning member 101 of the jig 100A according to the present variation.

The pressed flat spring 410 includes a bending portion 410b, a fixing portion 410a attached to the bottom surface of the jig 100A, and an operation portion 410c (e.g. a lever) which penetrates the through-hole 401 and is located on side of the jig 100A opposite the bottom side thereof. The operation portion 410c includes a pressed portion 411 which projects from the operation portion 410c. Alternatively, the pressed portion 411 can be a marking to locate visually the position pressed by the user, and may be an engraved mark, a seal, or the like. Further, as illustrated in FIG. 26, the operation portion 410c includes a projecting portion 412 projecting in a hemispherical shape. The projecting portion 412 is disposed on the surface of the operation portion 410c opposite to the surface of the workbench and on the bent portion 410b side of the surface of the operation portion 410c.

The pressed flat spring 410 is fixed to the bottom face of the jig 100 by, for example, bonding, double-sided adhesive tape, or fastening with a screw.

As illustrated in FIG. 26, a plurality of high friction members 150 are provided on the bottom of the jig 100J according to the variation, similarly to the jig 100J according to the comparative example illustrated in FIG. 17.

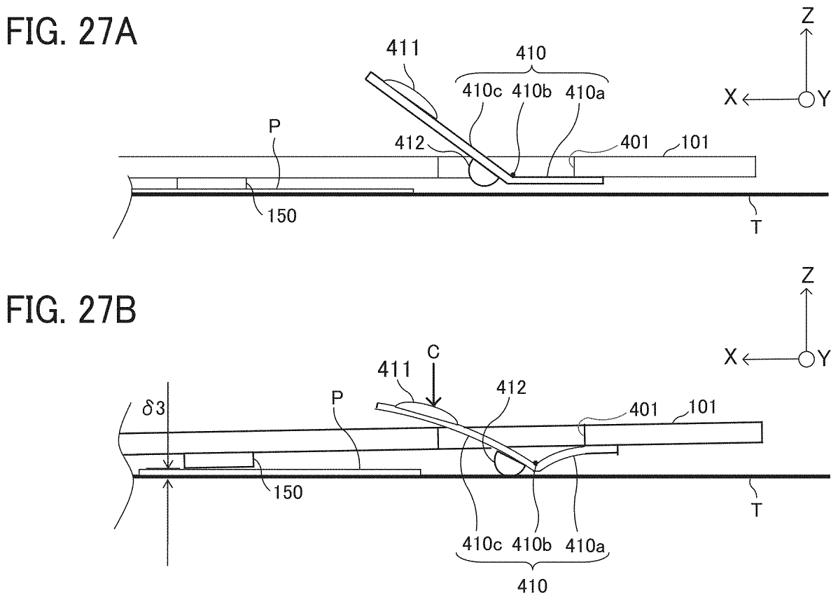

FIG. 27A and 27B are enlarged side views of a section indicated by a circle in FIG. 25. FIG. 27A is an illustration of a state when the pressed portion 411 is not pushed down and FIG. 27B is an illustration of a state when the pressed portion 411 is pushed down.

As illustrated in FIG. 27A, when the pressing portion 411 of the pressed flat spring 410 is not pushed down, the high friction members 150 are in contact with a paper sheet and the function of the high friction members 150 to prevent positional displacement from the paper sheet is in operating state. On the other hand, as illustrated in FIG. 27B, when the user pushes down the pressed portion 411 as indicated by arrow C in FIG. 27, an operation by a user the fixing portion 410a elastically deforms and the protruding portion 412 contacts the surface of the workbench T. Further, when the pressing portion 411 is pushed down, the jig 100A is lifted from the surface of the workbench T with respect to the protruding portion 412 serving as a fulcrum and the high friction members 150 are separated from the paper sheet. At this time, by setting these elements such that a clearance 63 between the high friction members 150 and the surface of the workbench T is thicker than that of a paper sheet, the function to prevent positional displacement from the paper sheet can be deactivated.

Preferably, the material and the shape of the pressing portion 411 are determined to enable the fixing portion 410a to elastically deform actively when the pressing portion 411 is pressed. As the fixing portion 410a is elastically deformed, the bent portion 410b and the operation portion 410c sink into the paper sheet side, and the projecting portion 412 easily contacts the paper sheet. Such a configuration brings an advantage that the jig 100A can be easily lifted with the projecting portion 412 as a fulcrum.

In the jig 100A according to the variation, as illustrated in FIG. 25, when the pressed flat spring 410 is pressed, a vicinity of a joining segment between the orthogonal-direction positioning member 101 and the sheet positioning reference member 102 is lifted by the projecting portion 412 of the pressed flat spring 410. The jig 100A is supported by three points; the projecting portion 412, an end 400c (see FIG. 25) of the orthogonal-direction positioning member 101 opposite to the sheet positioning reference member 102, and an end 400b (see FIG. 25) opposite to the orthogonal-direction positioning member 101 of the sheet positioning reference member 102. As a result, the orthogonal-direction positioning member 101 floats up in an oblique posture in which the spatial distance to the surface of the workbench gradually narrows toward the end 400c, and the sheet positioning reference member 102 floats up in an oblique posture such that the spatial distance to the surface of the workbench gradually narrows toward the end 400b.

In this manner, as the jig 100A is lifted, the high friction members 150 are separated from the paper sheet. Therefore, the wrapping sheet P placed in between the surface of the workbench and the jig 100A placed on the workbench can be moved relative to the jig 100A and the relative positions of the wrapping sheet P and the jig 100A can be adjusted. As a result, compared with the case where the user needs to hold and lift the jig 100A as a whole to adjust the relative positions of the jig 100A and the wrapping sheet P, the user can quickly adjust the relative positions.

Further, it is preferable that a material with lower friction coefficient with the paper sheet than that of the pressed flat spring 410 with the paper sheet is used for the projecting portion 412. Use of a low friction material for the projecting portion 412 can reduce the sliding friction between the projecting portion 412 and the paper sheet and when the projecting portion 412 is in contact with the paper sheet, the paper sheet can be moved relatively favorably with respected to the jig 100A.

A lifted position of the jig 100A lifted by the projecting portion 412 (the position at which the projecting portion 412 contacts the surface of the workbench or the paper sheet) is described below. Referring to FIG. 25, preferably, in the scanning direction (X direction), the lifted position of the jig 100A is in a first region extending from the center to the sheet positioning reference member 102 side end, as indicated by L1. In the orthogonal direction (Y direction), the lifted position of the jig 100A is preferably in a region extending from the center to the end of the orthogonal-direction positioning member 101, as illustrated by L2. By setting the lifted portion of the jig 100A to be lifted by the projecting portion 412 in the above-mentioned regions, the jig 100A can be set in a floating state, except on following three points; the projecting portion 412, the end 400c of the orthogonal-direction positioning member 101 opposite to the sheet positioning reference member 102, and the end 400b opposite to the orthogonal-direction positioning member 101 of the sheet positioning reference member 102.

In this way, when the adjustment of relative positions between the jig 100 and the wrapping sheet P is complete and the user releases the hand from the pressed portion 411, the floating state of the jig 100A is canceled. Then, the high friction members 150 contact the paper sheet and the positional displacement prevention function of the high friction members 150 is activated. Thus, the paper sheet relatively moves with respect to the jig 100A and the relative positional displacement between the paper sheet and the jig 100 can be reduced. Then, in the same manner as the above-described embodiment, the user sets again the handheld printer 1 relative to the jig 100, with the projections 201 of the attachment 200 of the handheld printer 1 inserted in the groove 110 of the jig 100 and positions the handheld printer 1 at the predetermined scanning start position (home position) in the scanning direction. After the handheld printer 1 is positioned, the user presses the print button 14 and moves the handheld printer 1 (manual scanning) in the scanning direction (X direction) so that the projections 201 of the handheld printer 1 move along the groove 110 of the jig 100 and forms an image at the target position of the wrapping sheet P. At this time, by moving the handheld printer 1 while holding the jig with one hand, the effect of the sheet positional displacement prevention of the high friction members 150 is further enhanced.

In the jig 100 of the embodiment described above, when the pressed portion 170 is not pressed, the high friction members 150 are not in contact with a paper sheet. Therefore, the paper sheet may move unexpectedly when, for example, the user leaves the apparatus temporarily. As a result, there is a possibility that the relative positions of the paper sheet with the jig may be shifted. On the contrary, in the jig 100A according to the variation, when the pressed flat spring 410 is not pressed, the high friction members 150 are in contact with a paper sheet. Therefore, even when, for example, the user leaves the apparatus temporarily, the relative positional displacement between the jig and the paper sheet can be suppressed.

On the other hand, in the jig 100 of the above-described embodiment, the relative positions between the jig 100 and the paper sheet can be adjusted without pressing the pressed portion 170. There is an advantage that relative position adjustment between the jig 100 and the paper sheet can be performed easily. Furthermore, in the embodiment described above, pressing the pressed portion 170 restricts the relative movement of the paper sheet with respect to the jig 100. There is an advantage that it is easy to operate intuitively.

Aspect 1

Aspect 1 concerns a jig (for example, the jig 100) for forming an image on a recording medium (for example, the wrapping sheet P) by movement of a mobile image forming apparatus (for example, the handheld printer 1) in a scanning direction (for example, the X-axis direction). The jig includes an apparatus positioning reference (for example, the groove 110) serving as a reference for positioning the mobile image forming apparatus in the orthogonal direction (for example, the Y-axis direction) orthogonal to the scanning direction. The jig further includes displacement stopper (for example, the high friction members 150) and a switching device. The displacement stopper is configured to prevent a relative positional displacement between the jig and the recording medium, and the switching device is configured to switch the displacement stopper between an operating state and a non-operating state.

The displacement stopper, such as a rubber sheet, is disposed on a medium-opposed face of the jig to oppose the recording medium, in order to firmly hold down the recording medium in formation of an image on the recording medium. Thus, the displacement stopper can inhibit the relative positional displacement between the recording medium and the jig. However, at the time of aligning the jig for the mobile image forming apparatus with the recording medium, the displacement stopper hinders the relative movement therebetween. The user is prevented from sliding the jig on the recording medium to change the position of the jig thereon. Therefore, in adjustment of the relative positions between the jig and the recording medium, the user needs to lift the jig, with his or her hand, to move the jig relative to the recording medium. Thus, it takes time to adjust the relative positions.

On the other hand, by eliminating the displacement stopper such as rubber, the jig for the mobile image forming apparatus can be slid and moved on the recording medium, thereby enabling quick adjustment of the relative positions between the jig and the recording medium. In such a structure, however, the recording medium is not reliably held down with the jig in formation of an image on the recording medium. Accordingly, the recording medium may move relative to the jig, and the recording medium may shift.

Therefore, in Aspect 1, the switching device is configured to switch the displacement stopper between the operating state and the non-operating state. With this configuration, when an image is formed on the recording medium, the displacement stopper is activated (in the operating state) to prevent the displacement of the recording medium. Thus, image can be formed at a desired position on the recording medium. When performing alignment between the recording medium and the jig, the displacement stopper is inactivated (in the non-operating state) to enable the jig to slide on the recording medium to move relative to the recording medium. Accordingly, compared with the case where the user lifts and moves the jig, the alignment between the jig and the recording medium can be performed quickly.

Accordingly, displacement of the recording medium can be inhibited in formation of an image on the recording medium, and the time required for relative position adjustment between the jig and the recording medium can be reduced.

Aspect 2

In Aspect 1, the displacement stopper is a high friction member (for example, the high friction members 150) higher in friction coefficient with the recording medium than a medium-opposed face (e.g., the bottom face 104 of the jig 100, see FIG. 10) of the jig to oppose the recording medium, and the high friction member is configured to move between a contact position in contact with the recording medium and a retracted position retracted from the recording medium.

According to this, as described in the above-described embodiment, as the high friction member contacts the recording medium such as the paper sheet, the frictional force between the high friction member and the recording medium can inhibit the recording medium from moving relative to the jig. Then, the prevention of the relative displacement between the recording medium and the jig is in the operating state. On the other hand, as the high friction member is retracted from the contact position with the recording medium to the retracted position, the high friction member becomes contactless with the recording medium. Then, the prevention of the relative displacement between the recording medium and the jig is in the non-operating state.

Aspect 3

In Aspect 2, in a direction perpendicular to the surface of the recording medium such as a paper sheet, the retracted position is farther from the surface of the recording medium than a portion (for example, the first and second surface contact legs 180a and 180b) of the jig that contacts the surface of the recording medium when the jig is set on the recording medium or a table on which the recording medium is placed.

According to this, as described in the embodiment, when the high friction member is in the retracted position, the high friction member can be contactless with the recording medium.

Aspect 4

In any one of Aspects 1 to 3, the jig further includes an operation portion such as the pressed portion 170 that switches the displacement stopper (such as the high friction members 150) from the non-operating state to the operating state by a user operation.

According to this, as described in the embodiment, the relative positions between the jig and the recording medium can be adjusted by the operation of the operation portion. Thus, the relative positions between the jig and the recording medium can be easily adjusted.

Aspect 5

In Aspect 4, when the user presses the operation portion, the displacement stopper is set in the operating state.

With this configuration, as described above in the embodiment, the jig can be easily operated by the user intuitively.

Aspect 6

In Aspect 4 or 5, when the operator releases the hand from the operation portion, the operating state is automatically switched to the non-operating state.

The user can switch the displacement stopper from the operating state to the non-operating state by releasing the hand from the operation portion. Thus, time and effort can be saved in switching from the operating state to the non-operating state, and the usability of the jig is improved.

Aspect 7

The jig according to Aspect 6 further includes a biasing member, such as the compression coil spring 171, to bias the operation portion in the direction opposite to the operation direction in which the operation portion, such as the pressed portion 170, is operated for the switching from the non-operating state to the operating state.

According to this, the structure according to Aspect 6 can be realized with a simple configuration.

Aspect 8

The jig according to any one of Aspects 4 to 7 further includes a movement restrictor (in the above-described embodiment, the positioning portion 170c and the positioning holes 174a and 174b together serve as the movement restrictor) to restrict the operation portion, such as the pressed portion 170, from moving in the direction orthogonal to the operation direction.

Such a structure can prevent the recording medium from moving together with the pressed portion 170 in a state where the high friction members 150 are in contact with the recording medium. Thus, the jig can prevent changes in the relative positions between the recording medium and the jig.

Aspect 9

The jig according to any one of Aspects 4 to 8 further includes a contact protrusion (such as the first and second surface contact legs 180a and 180b) protruding from the medium-opposing face (such as the bottom face 104 of the jig 100) to oppose the recording medium (such as the paper sheet), and the contact protrusion is equal to or smaller than the medium-opposing face in friction coefficient with the recording medium.

As described in the above-described embodiment, this structure can facilitate insertion of the recording medium such as a paper sheet between the workbench and the jig placed on the workbench. Further, this structure can reduce the rubbing of the recording medium when the jig is slid and moved on the recording medium.

Aspect 10

In Aspect 9, the contact protrusion, such as the first and second surface contact legs 180a and 180b, is integrally molded with the base (such as the base 103) of the jig.

According to this, the manufacturing cost can be reduced, and the jig can be inexpensive.

Aspect 11

In Aspect 9 or 10, the contact protrusion (such as the first surface contact leg 180a or the second surface contact leg 180b) is provided, at least, on one end of the jig in the scanning direction.

According to this, as described with reference to FIG. 19, depending on the size of the recording medium such as a paper sheet, the image formation position, and the like, the relative positions between the recording medium and the jig can be adjusted without the rubbing between the jig and the recording medium.

Aspect 12

The jig according to any one of Aspects 1 to 3 includes an operation portion (such as the pressed flat spring 410) to switch the displacement stopper from the operating state to the non-operating state by a user operation.

According to this, as described in the variation, when the user does not operate the operation portion such as the pressed flat spring 410, the displacement stopper is in the operating state. As a result, even when the operation portion is temporarily not operated (for example, the user temporarily leave the place), the relative positions between the recording medium and the jig does not change.

Aspect 13

In Aspect 12, when the user presses the operation portion, the displacement stopper is set in the non-operating state.

According to this, a simple operation of pressing enables the switching from the operating state to the non-operating state.

Aspect 14

in Aspect 12 or 13, the operation portion (for example, the pressed flat spring 410) is configured to float a portion of the jig by a user operation, thereby switching the displacement stopper from the operating state to the non-operating state.

According to this, as described in the embodiment, as a part of the jig floats up, the displacement stopper such as the high friction members 150 can be separated from the recording medium such as a paper sheet, thereby deactivating the displacement stopper.

Aspect 15

In Aspect 14, the operation portion is a plate spring (such as the pressed flat spring 410) including a bending portion (such as the bending portion 410b), a first end side secured to the jig (for example, the base 103 of the jig 100A), and a second end side opposite the first end side with respect to the bending portion. The second end side is to be operated by the user, and an operation by a user the first end side is elastically deformed when the user operates the second end side.

According to this, as the first end side with respect to the bending portion 410b elastically deforms, the operation portion separated from the recording medium comes into contact with the recording medium and lifts the jig with the operation portion serving as a fulcrum. Then, the displacement stopper such as the high friction members 150 can be separated from the recording medium and brought into the non-operating state.

Aspect 16

In Aspect 15, the base (such as the base 103) of the jig includes a first portion (for example, the orthogonal-direction positioning member 101) extending in a first direction aligned with the scanning direction and including the apparatus positioning reference such as the groove 110. The base further includes a second portion (for example, the sheet positioning reference member 102) extending, from an end in the first direction of the first portion, in a second direction orthogonal to the first direction. The first portion serves as a positioning reference for the apparatus in the second direction orthogonal to the scanning direction (an orthogonal-direction positioning reference). The second portion serves as a positioning reference for the recording medium (a medium positioning reference). In this structure, the operation portion (such as the pressed flat spring 410), that is, the lifted portion of the jig (e.g., the jig 100A), is disposed in either a first region (e.g., the region L1 in FIG. 25) extending from a center of the first portion (e.g.,, the orthogonal-direction positioning member 101) to the end portion of the first portion in the first direction, or a second region (e.g., the region L2 in FIG. 25) extending from a center of the second portion (e.g., the sheet positioning reference member 102) to an end of the second portion on a side of the first portion in the second direction.

According to this, as described in the variation, with the operation of the operation portion (such as the pressed flat spring 410), the second portion (i.e., the medium positioning reference such as the sheet positioning reference member 102) and the first portion (such as the orthogonal-direction positioning member 101) are lifted.

Aspect 17

Aspect 17 concerns a mobile image forming system that includes a mobile image forming apparatus (such as the handheld printer 1) to form an image on a recording medium (such as a paper sheet) while manually moved in the scanning direction, and the jig according to any one of Aspects 1 to 16.

According to this, relative position adjustment between the jig and the recording medium such as a paper sheet can be quickly performed, and relative displacement between the recording medium and the jig can be inhibited.

Aspect 18

Aspect 20 concerns a jig set for a mobile image forming apparatus. The jig set includes the jig according to any one of Aspects 1 to 16 and an attachment (i.e., a contacted component such as the attachment 200) to be attached to the mobile image forming apparatus (for example, the handheld printer 1), thereby providing a contacted portion to which the apparatus positioning reference (for example, the groove 110) of the jig contacts (for example, the contacted portion is inserted into the groove 110).

According to this, relative position adjustment between the jig and the recording medium such as a paper sheet can be quickly performed, and relative displacement between the recording medium and the jig can be inhibited.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A jig for an image forming apparatus that forms an image on a recording medium with movement in a scanning direction, the jig comprising:
a base including an apparatus positioning reference extending in a first direction to be aligned with the scanning direction, the apparatus positioning reference being a reference in positioning the image forming apparatus in a second direction orthogonal to the first direction;
a displacement stopper configured to prevent a relative positional displacement between the jig and the recording medium; and
a switching device configured to switch the displacement stopper between an operating state and a non-operating state.

2. The jig according to claim 1,
wherein the displacement stopper is disposed on a face of the jig to oppose the recording medium,
wherein the displacement stopper is higher in friction coefficient with the recording medium than the face of the jig to oppose the recording medium, and
wherein the displacement stopper is configured to move between a contact position to contact the recording medium and a retracted position retracted from the recording medium.

3. The jig according to claim 2,
wherein, in a direction perpendicular to a surface of the recording medium, the retracted position is farther from the surface of the recording medium than a portion of the jig that contacts the surface of the recording medium or a table on which the recording medium is placed when the jig is set on the recording medium.

4. The jig according to claim 1,
wherein the switching device includes an operation portion configured to switch the displacement stopper from the non-operating state to the operating state by an operation by a user.

5. The jig according to claim 4,
wherein the displacement stopper is set in the operating state by pressing of the operation portion by the user.

6. The jig according to claim 4,
wherein the operation portion is configured to switch the displacement stopper from the operating state to the non-operating state by releasing of the operation portion by the user.

7. The jig according to claim 6,
wherein the switching device includes a biasing member configured to bias the operation portion in a direction opposite to an operation direction in which the operation portion is operated for switching the displacement stopper from the non-operating state to the operating state.

8. The jig according to claim 4, further comprising a movement restrictor configured to restrict the operation portion from moving in a direction orthogonal to an operation direction in which the operation portion is operated.

9. The jig according to claim 4, further comprising a contact protrusion protruding from a face of the jig to oppose the recording medium, the contact protrusion being equal to or smaller, in friction coefficient with the recording medium, than the face of the jig to oppose the recording medium.

10. The jig according to claim 9, wherein the contact protrusion is integrally molded with the base.

11. The jig according to claim 9,
wherein the contact protrusion is provided at, at least, one end of the jig in the first direction to be aligned with the scanning direction.

12. The jig according to claim 1, wherein the switching device includes an operation portion configured to switch the displacement stopper from the operating state to the non-operating state by an operation by a user.

13. The jig according to claim 12,
wherein the displacement stopper is set in the non-operating state by pressing of the operation portion by the user.

14. The jig according to claim 12,
wherein the operation portion is configured to float a portion of the jig by the operation by the user, to switch the displacement stopper from the operating state to the non-operating state.

15. The jig according to claim 14,
wherein the operation portion includes a plate spring, the plate spring including:
a bending portion;
a first end side secured to the base of the jig; and
a second end side opposite the first end side with respect to the bending portion, the second end side to be operated by the user, and
wherein at least the first end side is elastically deformable by an operation of the second end side by the user.

16. The jig according to claim 15,
wherein the base of the jig includes:
a first portion extending in the first direction to be aligned with the scanning direction, the first portion including the apparatus positioning reference; and
a second portion extending in the second direction from an end in the first direction of the first portion, the second portion being a positioning reference for the recording medium, and
wherein the operation portion is disposed in either a first region or a second region, the first region extending from a center of the first portion to the end in the first direction of the first portion, the second region extending from a center of the second portion to an end of the second portion on a side of the first portion in the second direction.

17. An image forming system comprising:
the image forming apparatus; and
the jig according to claim 1, to be used in positioning the image forming apparatus.

18. A jig set for an image forming apparatus, the jig set comprising:
the jig according claim 1; and
an attachment to be attached to the image forming apparatus, the attachment including a contacted portion that the apparatus positioning reference contacts when the attachment is attached to the image forming apparatus.
